(19) United States
(12) Patent Application Publication
(10) Pub. No.: US 2013/0307832 A1
(43) Pub. Date: Nov. 21, 2013

(54) PLASMA DISPLAY PANEL DRIVE METHOD AND PLASMA DISPLAY DEVICE

(71) Applicants: Yuya Shiozaki, Osaka (JP); Takahiko Origuchi, Osaka (JP); Ayuhiko Saito, Osaka (JP); Yuichi Sakai, Osaka (JP); Yuki Imai, Osaka (JP)

(72) Inventors: Yuya Shiozaki, Osaka (JP); Takahiko Origuchi, Osaka (JP); Ayuhiko Saito, Osaka (JP); Yuichi Sakai, Osaka (JP); Yuki Imai, Osaka (JP)

(73) Assignee: PANASONIC CORPORATION, Osaka (JP)

(21) Appl. No.: 13/981,909

(22) PCT Filed: Jan. 25, 2012
(86) PCT No.: PCT/JP2012/000445

§ 371 Date: Jul. 25, 2013

(30) Foreign Application Priority Data
Jan. 28, 2011 (JP) 2011-016039

(51) Int. Cl. G09G 3/296

(52) U.S. Cl. CPC G09G 3/296
USPC 345/208; 345/60

(57) ABSTRACT

A stable address operation is performed also when a plasma display panel having a high definition and large screen is driven. For this purpose, a driving method of a plasma display panel is provided. The panel is driven by forming one field using a plurality of subfields each of which has an address period and a sustain period in which sustain pulses varying from a base potential to a voltage at which a sustain discharge is caused in the discharge cell having undergone the address discharge are applied to the display electrode pairs. In the driving method, after generation of the final sustain pulse in the sustain period, an up-ramp waveform voltage which increases from the base potential to a predetermined voltage is applied to the scan electrodes. The predetermined voltage is set lower than the voltage of the sustain pulses.

### TECHNICAL FIELD

The present invention relates to a plasma display apparatus using an alternating-current surface discharge type plasma display panel, and a driving method of the plasma display panel.

### BACKGROUND ART

An alternating-current surface discharge type panel typical as a plasma display panel (hereinafter referred to as “panel”) has many discharge cells between a front substrate and a rear substrate that are faced to each other.

The front substrate has the following elements:
a plurality of display electrode pairs disposed in parallel on a front glass substrate; and
a dielectric layer and protective layer disposed so as to cover the display electrode pairs.
   Here, each display electrode pair is formed of a pair of scan electrode and sustain electrode.

The rear substrate has the following elements:
a plurality of data electrodes disposed in parallel on a rear glass substrate;
a dielectric layer disposed so as to cover the data electrodes;
a plurality of barrier ribs disposed on the dielectric layer in parallel with the data electrodes; and
phosphor layers disposed on the surface of the dielectric layer and on the side surfaces of the barrier ribs.

The front substrate and rear substrate are faced to each other so that the display electrode pairs and the data electrodes intersect three-dimensionally, and are sealed. Discharge gas containing xenon with a partial pressure ratio of 5%, for example, is filled into a discharge space in the sealed product. Discharge cells are disposed in the intersecting parts of the display electrode pairs and the data electrodes. In the panel having such a structure, ultraviolet rays are emitted by gas discharge in each discharge cell. The ultraviolet rays excite respective phosphors of red (R), green (G), and blue (B) to emit light, and thus provide color image display.

A subfield method is generally used as a method of displaying an image in an image display region of the panel by combining binary controls of light emission and no light emission in a discharge cell.

In this subfield method, one field is divided into a plurality of subfields of different light emission luminances. In each discharge cell, light emission and no light emission of each subfield are controlled based on a combination corresponding to a desired gradation value. Thus, the emission luminance of one field is set at the desired gradation value to emit light in each discharge cell, and an image using a combination of various gradation values is displayed in the image display region of the panel.

In the subfield method, each subfield has an initializing period, an address period, and a sustain period.

In the initializing period, an initializing operation of applying an initializing waveform to each scan electrode and causing initializing discharge in each discharge cell is performed. Thus, wall charge required for the subsequent address operation is produced in each discharge cell, and a priming particle (an excitation particle for causing discharge) for stably causing address discharge is generated.

In the address period, scan pulses are sequentially applied to scan electrodes, and address pulses are selectively applied to data electrodes based on an image signal to be displayed. Thus, address discharge is caused between the scan electrode and the data electrode of the discharge cell to emit light, thereby producing wall charge in the discharge cell (hereinafter, this operation is also collectively referred to as “address”).

In the sustain period, as many sustain pulses as a number based on the luminance weight determined for each subfield are alternately applied to the display electrode pairs formed of the scan electrodes and the sustain electrodes. Thus, sustain discharge is caused in the discharge cell having undergone address discharge, thereby emitting light in the phosphor layer of the discharge cell (hereinafter, light emission by sustain discharge in a discharge cell is referred to as “lighting”, and no light emission is referred to as “no lighting”). Thus, light is emitted in each discharge cell at a luminance corresponding to the luminance weight in each subfield. Thus, light is emitted at a luminance corresponding to the gradation value of an image signal in each discharge cell of the panel, and an image is displayed in the image display region of the panel.

A technology is disposed (for example, Patent Literature 1) in which, after the application of the sustain pulses to the display electrode pairs is completed in the sustain period, an increasing ramp voltage is applied to the sustain electrodes to cause feeble discharge (erasing discharge). By causing the erasing discharge, the wall charge in the discharge cells produced by the sustain discharge is erased to reduce the potential difference between the display electrode pairs, and address discharge can be stably caused in the address period of the subsequent subfield.

A technology is disposed (for example, Patent Literature 2) in which, after the application of the sustain pulses to the display electrode pairs is completed in the sustain period, a ramp voltage that increases to a predetermined voltage and remains at the predetermined voltage for a certain period is applied to the scan electrodes, and an increasing ramp voltage is applied to the sustain electrodes to erase the wall charge in the discharge cells.

A technology is disposed (for example, Patent Literature 3) in which, after the application of the sustain pulses to the display electrode pairs is completed in the sustain period, an increasing ramp voltage is applied to the scan electrodes and the gradient of the ramp voltage is varied in response to the average luminance of the display image, thereby erasing the wall charge in the discharge cells.

In a panel having a high definition and large screen, the number of electrodes to be driven is increased and the impedance during driving is increased, so that the address operation is apt to become unstable. Therefore, also in a plasma display apparatus having such a panel, it is required to stably cause address discharge and stably display an image on the panel.

### CITATION LIST

### Patent Literature

PTL 1 Unexamined Japanese Patent Publication No. 2004-348140
PTL 2 Unexamined Japanese Patent Publication No. 2005-141224
PTL 3 Unexamined Japanese Patent Publication No. 2003-5700

### SUMMARY OF THE INVENTION

In a driving method of a panel of the present invention, a panel including a plurality of discharge cells each of which has a data electrode and a display electrode pair formed of a scan electrode and sustain electrode is driven by forming one field using a plurality of subfields having an address period and sustain period. Here, in the address period, address discharge is caused in a discharge cell to emit light. In the sustain period, sustain pulses that vary from a base potential to a voltage at which sustain discharge is caused in the discharge cell having undergone address discharge are applied to the display electrode pairs. In this driving method, after generation of the final sustain pulse in the sustain period, an up-ramp waveform voltage which increases from the base potential to a predetermined voltage is applied to the scan electrodes. The predetermined voltage is set lower than the voltage of the sustain pulse.

Thus, also when a panel having a high definition and large screen is driven, a stable address operation can be performed and a high-quality image can be displayed on the panel.

In a driving method of a panel of the present invention, a panel including a plurality of discharge cells each of which has a data electrode and a display electrode pair formed of a scan electrode and sustain electrode is driven by forming one field using a plurality of subfields having an address period and sustain period. Here, in the address period, address discharge is caused in a discharge cell to emit light. In the sustain period, sustain pulses that vary from the base potential to the voltage at which sustain discharge is caused in the discharge cell having undergone address discharge are applied to the display electrode pairs. In this driving method, in the subfields other than the final subfield in one field, after generation of the final sustain pulse in the sustain period, an up-ramp waveform voltage which increases from the base potential to a predetermined voltage set lower than the voltage of the sustain pulse is applied to the scan electrodes. In the final subfield in one field, after the generation of the final sustain pulse in the sustain period, an up-ramp waveform voltage which increases from the base potential to a voltage set equal to or higher than the voltage of the sustain pulse is applied to the scan electrodes.

Thus, also when a panel having a high definition and large screen is driven, a stable address operation can be performed and a high-quality image can be displayed on the panel.

In a driving method of a panel of the present invention, a panel including a plurality of discharge cells each of which has a data electrode and a display electrode pair formed of a scan electrode and sustain electrode is driven by forming one field using a plurality of subfields having an initializing period, address period, and sustain period. Here, in the address period, address discharge is caused in a discharge cell to emit light. In the sustain period, sustain pulses that vary from the base potential to the voltage at which sustain discharge is caused in the discharge cell having undergone address discharge are applied to the display electrode pairs. In this driving method, a first-kind subfield and second-kind subfield are disposed in one field. In the first-kind subfield, in the initializing period, there are the following scan electrodes:
scan electrodes to which an up-ramp waveform voltage that increases to a voltage at which discharge occurs in the discharge cells and a first down-ramp waveform voltage that decreases to a negative voltage are applied; and
scan electrodes to which a voltage at which no discharge occurs in the discharge cells and the first down-ramp waveform voltage are applied.
   In the second-kind subfield, a second down-ramp wave form is applied to the scan electrodes in the initializing period, the second down-ramp waveform voltage decreasing to a voltage at which discharge occurs only in the discharge cell having undergone address discharge in the immediately preceding subfield. In the period when the first down-ramp waveform voltage is applied to the scan electrodes in the initializing period of the first-kind subfield, a first voltage is applied to the data electrodes. In the period when the second down-ramp waveform voltage is applied to the scan electrodes in the initializing period of the second-kind subfield, a second voltage higher than the first voltage is applied to the data electrodes. In the subfields other than the final subfield in one field, after generation of the final sustain pulse in the sustain period, an up-ramp waveform voltage which increases from the base potential to a predetermined voltage set lower than the voltage of the sustain pulse is applied to the scan electrodes. In the final subfield in one field, after generation of the final sustain pulse in the sustain period, an up-ramp waveform voltage which increases from the base potential to a voltage set equal to or higher than the voltage of the sustain pulse is applied to the scan electrodes.

Thus, also when a panel having a high definition and large screen is driven, a stable address operation can be performed and a high-quality image can be displayed on the panel. The luminance of black level can be reduced, and a high-contrast image can be displayed on the panel.

In a driving method of a panel of the present invention, the second down-ramp waveform voltage may be generated such that the lowest voltage of the second down-ramp waveform voltage is higher than the lowest voltage of the first down-ramp waveform voltage.

In a driving method of a panel of the present invention, a positive voltage may be applied to the sustain electrodes in the period when the first down-ramp waveform voltage is applied to the scan electrodes, and a voltage higher than the positive voltage may be applied to the sustain electrodes in the period when the second down-ramp waveform voltage is applied to the scan electrodes.

In a driving method of a panel of the present invention, preferably, the up-ramp waveform voltage that is applied to the scan electrodes after generation of the sustain pulses in the sustain period has a gradient steeper than that of the up-ramp waveform voltage that is applied to the scan electrodes in the initializing period of the first-kind subfield.

A plasma display apparatus of the present invention includes a panel having a plurality of discharge cells each of which has a data electrode and a display electrode pair formed of a scan electrode and sustain electrode, and a driver circuit for driving the panel by forming one field using a plurality of subfields having an address period and sustain period. Here, in the address period, address discharge is caused in a discharge cell to emit light. In the sustain period, sustain pulses that vary from a base potential to a voltage at which sustain discharge is caused in the discharge cell having undergone address discharge are applied to the display electrode pairs. In this plasma display apparatus, after generation of the final sustain pulse in the sustain period, the driver circuit applies, to the scan electrodes, an up-ramp waveform voltage which increases from the base potential to a predetermined voltage set lower than the voltage of the sustain pulse.

Thus, also when a panel having a high definition and large screen is driven, a stable address operation can be performed and a high-quality image can be displayed on the panel.

A plasma display apparatus of the present invention includes a panel having a plurality of discharge cells each of which has a data electrode and a display electrode pair formed of a scan electrode and sustain electrode, and a driver circuit for driving the panel by forming one field using a plurality of subfields having an address period and sustain period. Here, in the address period, address discharge is caused in a discharge cell to emit light. In the sustain period, sustain pulses that vary from the base potential to the voltage at which sustain discharge is caused in the discharge cell having undergone address discharge are applied to the display electrode pairs. In this plasma display apparatus, in the subfields other than the final subfield in one field, after generation of the final sustain pulse in the sustain period, the driver circuit applies, to the scan electrodes, an up-ramp waveform voltage which increases from the base potential to a predetermined voltage set lower than the voltage of the sustain pulse. In the final subfield in one field, after generation of the final sustain pulse in the sustain period, the driver circuit applies, to the scan electrodes, an up-ramp waveform voltage which increases from the base potential to a voltage set equal to or higher than the voltage of the sustain pulse.

Thus, also when a panel having a high definition and large screen is driven, a stable address operation can be performed and a high-quality image can be displayed on the panel.

A plasma display apparatus of the present invention includes a panel having a plurality of discharge cells each of which has a data electrode and a display electrode pair formed of a scan electrode and sustain electrode, and a driver circuit for driving the panel by forming one field using a plurality of subfields having an initializing period, address period, and sustain period. Here, in the address period, address discharge is caused in a discharge cell to emit light. In the sustain period, sustain pulses that vary from a base potential to the voltage at which sustain discharge is caused in the discharge cell having undergone address discharge are applied to the display electrode pairs. In this plasma display apparatus, the driver circuit forms a first-kind subfield and second-kind subfield in one field, and drives the panel. In the first-kind subfield, in the initializing period, there are the following scan electrodes:
scan electrodes to which an up-ramp waveform voltage that increases to a voltage at which discharge occurs in the discharge cells and a first down-ramp waveform voltage that decreases to a negative voltage are applied; and
scan electrodes to which a voltage at which no discharge occurs in the discharge cells and the first down-ramp waveform voltage are applied.
   In the second-kind subfield, a second down-ramp wave form is applied to the scan electrodes in the initializing period, the second down-ramp waveform voltage decreasing to a voltage at which discharge occurs only in the discharge cell having undergone address discharge in the immediately preceding subfield. In the period when the first down-ramp waveform voltage is applied to the scan electrodes in the initializing period of the first-kind subfield, a first voltage is applied to the data electrodes. In the period when the second down-ramp waveform voltage is applied to the scan electrodes in the initializing period of the second-kind subfield, a second voltage higher than the first voltage is applied to the data electrodes. In the subfields other than the final subfield in one field, after generation of the final sustain pulse in the sustain period, an up-ramp waveform voltage which increases from the base potential to a predetermined voltage set lower than the voltage of the sustain pulse is applied to the scan electrodes. In the final subfield in one field, after generation of the final sustain pulse in the sustain period, an up-ramp waveform voltage which increases from the base potential to a voltage set equal to or higher than the voltage of the sustain pulse is applied to the scan electrodes.

Thus, also when a panel having a high definition and large screen is driven, a stable address operation can be performed and a high-quality image can be displayed on the panel. The luminance of black level can be reduced, and a high-contrast image can be displayed on the panel.

### BRIEF DESCRIPTION OF DRAWINGS

FIG. 1 is an exploded perspective view showing a structure of a panel used in a plasma display apparatus in accordance with a first exemplary embodiment of the present invention.

FIG. 2 is an electrode array diagram of the panel used in the plasma display apparatus in accordance with the first exemplary embodiment of the present invention.

FIG. 3 is a diagram showing a driving voltage waveform that is to be applied to each electrode of the panel used in the plasma display apparatus in accordance with the first exemplary embodiment of the present invention.

FIG. 4 is a diagram showing the relationship between the voltage difference between voltage Vr and voltage Vs and the voltage difference between voltage Vi4 and voltage Va in accordance with the first exemplary embodiment of the present invention.

FIG. 5 is a circuit block diagram of the plasma display apparatus in accordance with the first exemplary embodiment of the present invention.

FIG. 6 is a circuit diagram for schematically showing the configuration of a scan electrode driver circuit of the plasma display apparatus in accordance with the first exemplary embodiment of the present invention.

FIG. 7 is a circuit diagram for schematically showing the configuration of a sustain electrode driver circuit of the plasma display apparatus in accordance with the first exemplary embodiment of the present invention.

FIG. 8 is a circuit diagram for schematically showing the configuration of a data electrode driver circuit of the plasma display apparatus in accordance with the first exemplary embodiment of the present invention.

FIG. 9 is a diagram showing a driving voltage waveform that is to be applied to each electrode of the panel used in a plasma display apparatus in accordance with a second exemplary embodiment of the present invention.

FIG. 10 is a diagram for schematically showing the relationship between fields and scan electrodes to which a forced initializing waveform is applied in accordance with the second exemplary embodiment of the present invention.

FIG. 11 is a timing chart for illustrating the operation of the driver circuits of the plasma display apparatus in accordance with the second exemplary embodiment of the present invention.

FIG. 12 is a diagram showing an example of a driving voltage waveform that is to be applied to each electrode of the panel used in a plasma display apparatus in accordance with a third exemplary embodiment of the present invention.

FIG. 13 is a diagram showing another example of the driving voltage waveform that is to be applied to each electrode of the panel used in the plasma display apparatus in accordance with the third exemplary embodiment of the present invention.

FIG. 14 is a diagram showing another example of the waveform of an up-ramp waveform voltage generated for performing an erasing operation in the sustain period of the final subfield in one field in accordance with the third exemplary embodiment of the present invention.

FIG. 15 is a waveform chart showing another example of the waveform of a down-ramp waveform voltage to be applied to a scan electrode in accordance with the exemplary embodiments of the present invention.

### DESCRIPTION OF EMBODIMENTS

A plasma display apparatus in accordance with exemplary embodiments of the present invention will be described hereinafter with reference to the accompanying drawings.

### First Exemplary Embodiment

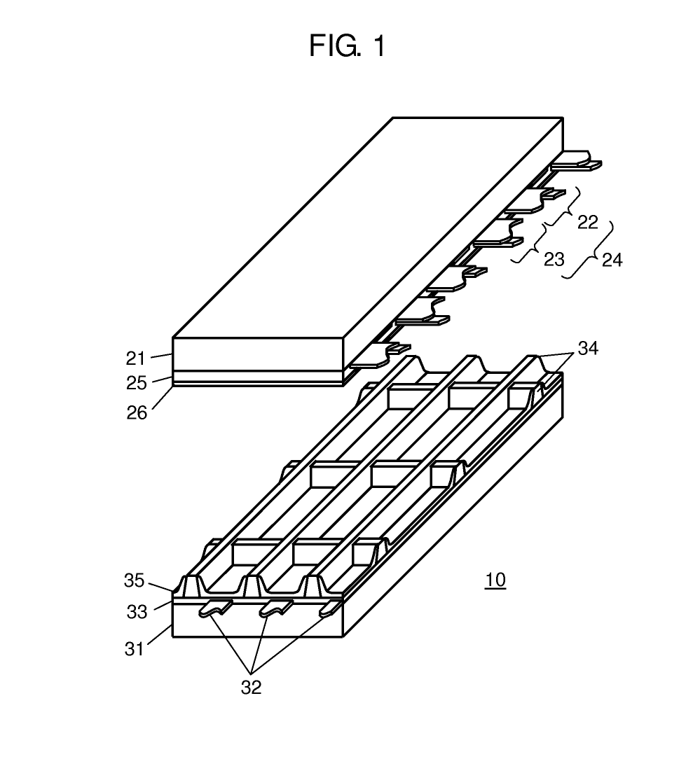

FIG. 1 is an exploded perspective view showing the structure of panel 10 used in a plasma display apparatus in accordance with a first exemplary embodiment of the present invention.

A plurality of display electrode pairs 24 formed of scan electrodes 22 and sustain electrodes 23 is disposed on glass-made front substrate 21. Dielectric layer 25 is formed so as to cover scan electrodes 22 and sustain electrodes 23, and protective layer 26 is formed on dielectric layer 25.

Protective layer 26 is made of a material mainly made of magnesium oxide (MgO) of high electron emission performance in order to facilitate generation of discharge in a discharge cell.

Protective layer 26 may be formed of one layer or a plurality of layers.

Particles may be disposed on the layer.

A plurality of data electrodes 32 is formed on rear substrate 31, dielectric layer 33 is formed so as to cover data electrodes 32, and mesh barrier ribs 34 are formed on dielectric layer 33. Phosphor layers 35 for emitting light of each of red color (R), green color (G), and blue color (B) are formed on the side surfaces of barrier ribs 34 and on dielectric layer 33.

Front substrate 21 and rear substrate 31 are faced to each other so that display electrode pairs 24 cross data electrodes 32 with a micro discharge space sandwiched between them, and a discharge space is disposed in the clearance between front substrate 21 and rear substrate 31. The outer periphery of the discharge space is sealed by a sealing material such as glass frit. The discharge space is filled with mixed gas of neon (Ne) and xenon (Xe) as discharge gas, for example.

The discharge space is partitioned into a plurality of sections by barrier ribs 34. Discharge cells constituting a pixel are formed in the intersecting parts of display electrode pairs 24 and data electrodes 32. Then, discharge is caused in these discharge cells and light is emitted (lighting) in the discharge cells, thereby displaying a color image on panel 10.

In panel 10, one pixel is formed of three consecutive discharge cells arranged in the extending direction of display electrode pairs 24. The three discharge cells are a discharge cell for emitting light of red color (R), a discharge cell for emitting light of green color (G), and a discharge cell for emitting light of blue color (B).

The structure of panel 10 is not limited to the above-mentioned one, but may be a structure having striped barrier ribs, for example. As the mixing ratio of the discharge gas, the xenon partial pressure may be 10%, for example. The xenon partial pressure may be increased in order to improve the luminous efficiency in the discharge cells. The other mixing ratio may be employed.

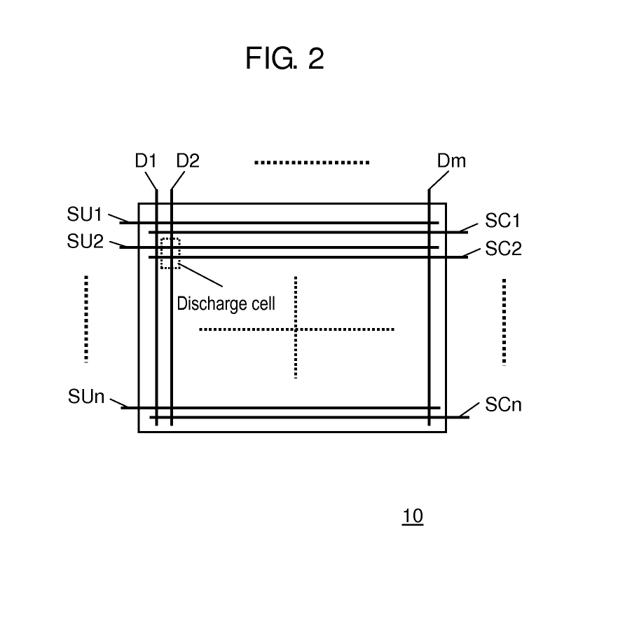

FIG. 2 is an electrode array diagram of panel 10 used for a plasma display apparatus in accordance with the first exemplary embodiment of the present invention.

Panel 10 has n scan electrode SC1 through scan electrode SCn (scan electrodes 22 in FIG. 1) and n sustain electrode SU1 through sustain electrode SUn (sustain electrodes 23 in FIG. 1) both extended in the horizontal direction (row direction, line direction), and m data electrode D1 through data electrode Dm (data electrodes 32 in FIG. 1) extended in the vertical direction (column direction).

One discharge cell is formed in the region where a pair of scan electrode SCi (i is 1 through n) and sustain electrode SUi intersect with one data electrode Dj (j is 1 through m). In other words, on one display electrode pair 24, m discharge cells are formed and m/3 pixels are formed. Thus, m×n discharge cells are formed in the discharge space, the region having m×n discharge cells defines the image display region of panel 10. In the panel where the number of pixels is 1920×1080, for example, m is 1920×3 and n is 1080. In the present exemplary embodiment, n is 1080, but the present invention is not limited to this numerical value.

Next, a driving method of panel 10 of the plasma display apparatus of the present exemplary embodiment is described. The plasma display apparatus of the present exemplary embodiment performs gradation display by a subfield method. In this subfield method, the plasma display apparatus divides one field into a plurality of subfields on the time axis, and sets luminance weight for each subfield. Each subfield has an initializing period, address period, and sustain period. The plasma display apparatus displays an image on panel 10 by controlling the light emission and no light emission of each discharge cell in each subfield.

Luminance weight means the ratio between the luminances displayed in respective subfields, and as many sustain pulses as the number corresponding to the luminance weight are generated in each subfield in the sustain period. Therefore, in the subfield of luminance weight “8”, for example, light is emitted at a luminance about eight times that in the subfield of luminance weight “1” and light is emitted at a luminance about four times that in the subfield of luminance weight “2”. Therefore, light is selectively emitted in each subfield based on a combination corresponding to an image signal, thereby displaying various gradations and displaying an image.

In the present exemplary embodiment, the following example is described:
one field is divided into 10 subfields (subfield SF1, subfield SF2, . . . , subfield SF10), and the respective subfields have luminance weights of (1, 2, 3, 6, 11, 18, 30, 44, 60, 80), so that a later subfield has a larger luminance weight.

In the present exemplary embodiment, a red image signal (R signal), green image signal (G signal), and blue image signal (B signal) can be displayed at 256 gradations of 0 to 255 with this configuration

In the initializing period, an initializing operation of causing the initializing discharge and producing wall charge required for the subsequent address discharge on each electrode is performed. The initializing operation at this time includes the following operations:
an all-cell initializing operation of causing initializing discharge in all discharge cells; and
a selective initializing operation of selectively causing initializing discharge in the discharge cell having undergone sustain discharge in the sustain period in the immediately preceding subfield.

In the address period, an address operation of selectively causing address discharge in the discharge cell to emit light and producing wall charge required for sustain discharge is performed.

In the sustain period, a sustain operation is performed where sustain pulses are alternately applied to display electrode pairs 24, and sustain discharge is caused in the discharge cell having undergone address discharge to emit light in the discharge cell.

In the present exemplary embodiment, the all-cell initializing operation is performed in the initializing period of one subfield, of the plurality of subfields, and a selective initializing operation is performed in the initializing periods of the other subfields. Hereinafter, a subfield where the all-cell initializing operation is performed is referred to as “all-cell initializing subfield”, and a subfield where the selective initializing operation is performed is referred to as “selective initializing subfield”.

In the present exemplary embodiment, the all-cell initializing operation is performed in the initializing period of subfield SF1, and the selective initializing operation is performed in the initializing periods of subfield SF2 through subfield SF10. Thus, light emission related to no image display is only light emission caused by discharge of the all-cell initializing operation in subfield SF1. Therefore, the luminance of black level as the luminance in the black displaying region, in which sustain discharge is not caused, is related to only feeble light emission in the all-cell initializing operation, and an image of high contrast can be displayed on panel 10.

In the sustain period of each subfield, as many sustain pulses as the number that is derived by multiplying the luminance weight of each subfield by a predetermined proportionality constant are applied to display electrode pairs 24, respectively. This proportionality constant is luminance magnification.

Therefore, when the luminance magnification is two, for example, four sustain pulses are applied to each of scan electrode 22 and sustain electrode 23 in the sustain period of the subfield of luminance weight “2”. The number of sustain pulses generated in the sustain period is therefore eight.

In the present exemplary embodiment, however, the number of subfields constituting one field and the luminance weight of each subfield are not limited to the above-mentioned values. The subfield structure may be changed based on an image signal or the like.

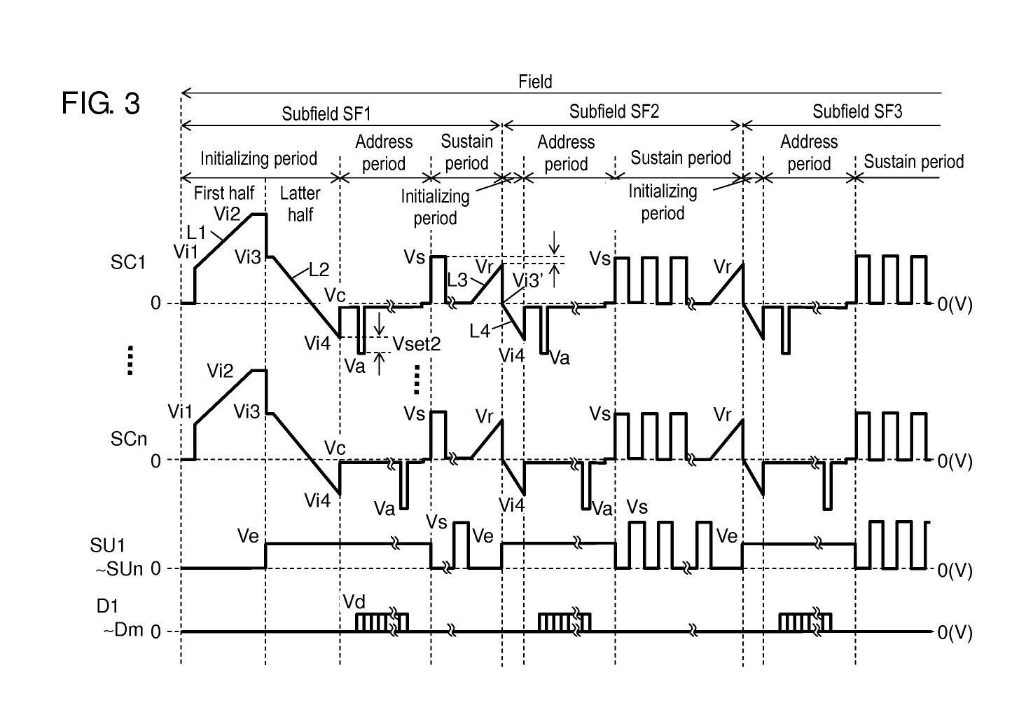

FIG. 3 is a diagram showing a driving voltage waveform that is to be applied to each electrode of panel 10 used in the plasma display apparatus in accordance with the first exemplary embodiment of the present invention.

FIG. 3 shows driving voltage waveforms applied to scan electrode SC1 for firstly undergoing an address operation in the address period, scan electrode SCn for finally undergoing the address operation in the address period, sustain electrode SU1 through sustain electrode SUn, and data electrode D1 through data electrode Dm.

FIG. 3 shows driving voltage waveforms of two subfields between which the waveform of the driving voltage applied to scan electrode SC1 through scan electrode SCn in the initializing period differs. The two subfields mean subfield SF1 as an all-cell initializing subfield, and subfield SF2 as a selective initializing subfield.

The driving voltage waveforms of the other subfields are substantially the same as the driving voltage waveform of subfield SF2 except for the number of generated sustain pulses in the sustain period. Each of scan electrode SCi, sustain electrode SUi, and data electrode Dk discussed later means the electrode that is selected from each kind of electrode based on image data (which indicates lighting or no lighting in each subfield).

First, subfield SF1 as an all-cell initializing subfield is described.

In the first half of the initializing period of subfield SF1, voltage 0 (V) is applied to data electrode D1 through data electrode Dm, and 0 (V) is applied to sustain electrode SU1 through sustain electrode SUn. Voltage Vi1 is applied to scan electrode SC1 through scan electrode SCn. Voltage Vi1 is set at a voltage lower than the discharge start voltage with respect to sustain electrode SU1 through sustain electrode SUn.

Then, to scan electrode SC1 through scan electrode SCn, a ramp waveform voltage which gently increases from voltage Vi1 to voltage Vi2 is applied. This ramp waveform voltage is hereinafter referred to as “up-ramp voltage L1”. Voltage Vi2 is set at a voltage exceeding the discharge start voltage with respect to sustain electrode SU1 through sustain electrode SUn. An example of the gradient of up-ramp voltage L1 has a numerical value of about 1.3 V/μsec.

While up-ramp voltage L1 increases, feeble initializing discharge continuously occurs between scan electrode SC1 through scan electrode SCn and sustain electrode SU1 through sustain electrode SUn, and between scan electrode SC1 through scan electrode SCn and data electrode D1 through data electrode Dm. Negative wall voltage is accumulated on scan electrode SC1 through scan electrode SCn, and positive wall voltage is accumulated on data electrode D1 through data electrode Dm and sustain electrode SU1 through sustain electrode SUn. Priming particles for supporting the generation of the later discharge are also generated.

The wall voltage on the electrodes means the voltage that is generated by the wall charge accumulated on the dielectric layers for covering the electrodes, the protective layer, or the phosphor layers.

In the latter half of the initializing period, positive voltage Ve is applied to sustain electrode SU1 through sustain electrode SUn. Voltage 0 (V) is applied as a first voltage to data electrode D1 through data electrode Dm. A first down-ramp waveform voltage which gently decreases from voltage Vi3 to negative voltage Vi4 is applied to scan electrode SC1 through scan electrode SCn.

Hereinafter, the first down-ramp waveform voltage is referred to as “down-ramp voltage L2”. Voltage Vi3 is set lower than the discharge start voltage with respect to sustain electrode SU1 through sustain electrode SUn, and voltage Vi4 is set at a voltage exceeding the discharge start voltage. An example of the gradient of down-ramp voltage L2 has a numerical value of about −2.5 V/μsec. Voltage Vi4 is equal to the voltage derived by adding voltage Vset2 to negative voltage Va when scan pulses are generated (described later).

While down-ramp voltage L2 is applied to scan electrode SC1 through scan electrode SCn, feeble initializing discharge occurs between scan electrode SC1 through scan electrode SCn and sustain electrode SU1 through sustain electrode SUn, and between scan electrode SC1 through scan electrode SCn and data electrode D1 through data electrode Dm.

Then, negative wall voltage on scan electrode SC1 through scan electrode SCn and positive wall voltage on sustain electrode SU1 through sustain electrode SUn are reduced, and the positive wall voltage on data electrode D1 through data electrode Dm is adjusted to a voltage appropriate to the address operation. Priming particles for supporting the generation of the later discharge are also generated. The priming particles shorten the discharge delay time of address discharge in the subsequent address period. The discharge delay time means the time length after the voltage applied to the discharge cell exceeds the discharge start voltage until discharge occurs actually.

Thus, the all-cell initializing operation for causing the initializing discharge in all discharge cells is completed.

Hereinafter, the period in which the all-cell initializing operation is performed is referred to as “all-cell initializing period”. The driving voltage waveform generated for performing the all-cell initializing operation is referred to as “all-cell initializing waveform”.

In the subsequent address period, scan pulses of voltage Va are sequentially applied to scan electrode SC1 through scan electrode SCn. An address pulse of positive voltage Vd is applied to data electrode Dk of the discharge cell to emit light, of data electrode D1 through data electrode Dm. Thus, address discharge is selectively caused in each discharge cell.

Specifically, continuing from the latter half of the initializing period, voltage 0 (V) is applied to data electrode D1 through data electrode Dm, voltage Ve is applied to sustain electrode SU1 through sustain electrode SUn, and voltage Vc is applied to scan electrode SC1 through scan electrode SCn.

Next, a scan pulse of negative voltage Va is applied to scan electrode SC1 of the first row to firstly undergo an address operation. An address pulse of positive voltage Vd is applied to data electrode Dk of the discharge cell to emit light in the first row, of data electrode D1 through data electrode Dm. At this time, the voltage difference in the intersecting part of data electrode Dk and scan electrode SC1 is derived by adding the difference between the wall voltage on data electrode Dk and the wall voltage on scan electrode SC1 to the difference between external applied voltages (voltage Vd−voltage Va). Thus, the voltage difference between data electrode Dk and scan electrode SC1 exceeds the discharge start voltage, and discharge occurs between data electrode Dk and scan electrode SC1.

Since voltage Ve is applied to sustain electrode SU1 through sustain electrode SUn, the voltage difference between sustain electrode SU1 and scan electrode SC1 is derived by adding the difference between the wall voltage on sustain electrode SU1 and the wall voltage on scan electrode SC1 to the difference between external applied voltages (voltage Ve−voltage Va). At this time, by setting voltage Ve at a value slightly lower than the discharge start voltage, the state can be provided where discharge does not occur but discharge is apt to occur between sustain electrode SU1 and scan electrode SC1.

Thus, discharge occurring between data electrode Dk and scan electrode SC1 causes discharge between sustain electrode SU1 and scan electrode SC1 that exist in a region crossing data electrode Dk. Thus, address discharge is caused in the discharge cell to emit light, positive wall voltage is accumulated on scan electrode SC1, negative wall voltage is accumulated on sustain electrode SU1, and negative wall voltage is also accumulated on data electrode Dk.

Thus, the address operation of causing address discharge in the discharge cell to emit light in the first row and accumulating wall voltage on each electrode is performed. The voltage in the intersecting part of scan electrode SC1 and data electrode 32 to which no address pulse is applied does not exceed the discharge start voltage, so that address discharge does not occur.

Next, a scan pulse is applied to scan electrode SC2 to secondly undergo an address operation, and an address pulse is applied to data electrode Dk corresponding to the discharge cell to emit light in the row to secondly undergo an address operation. In the discharge cell to which a scan pulse and address pulse are applied simultaneously, address discharge occurs and the address operation is performed.

The address operation is sequentially performed until the discharge cell of the n-th row. Then, the address period is completed. Thus, in the address period, address discharge is selectively caused in the discharge cell to emit light, and wall charge required for causing sustain discharge in the subsequent sustain period is produced in the discharge cell.

In the subsequent sustain period, voltage 0 (V) is applied to data electrode D1 through data electrode Dm. Voltage 0 (V) is applied to sustain electrode SU1 through sustain electrode SUn, and sustain pulses of positive voltage Vs are applied to scan electrode SC1 through scan electrode SCn. In the discharge cell having undergone address discharge, the voltage difference between scan electrode SCi and sustain electrode SUi is derived by adding the difference between the wall voltage on scan electrode SCi and the wall voltage on sustain electrode SUi to voltage Vs of the sustain pulses.

Thus, the voltage difference between scan electrode SCi and sustain electrode SUi exceeds the discharge start voltage, and sustain discharge occurs between scan electrode SCi and sustain electrode SUi. Then, ultraviolet rays generated by this discharge cause phosphor layers 35 to emit light. Due to this discharge, negative wall voltage is accumulated on scan electrode SCi, and positive wall voltage is accumulated on sustain electrode SUi. Positive wall voltage is also accumulated on data electrode Dk. In the discharge cell having undergone no address discharge in the address period, sustain discharge does not occur and the wall voltage at the completion of the initializing period is kept.

Subsequently, voltage 0 (V) is applied to scan electrode SC1 through scan electrode SCn, and sustain pulses of voltage Vs are applied to sustain electrode SU1 through sustain electrode SUn. In the discharge cell having undergone sustain discharge immediately before it, the voltage difference between sustain electrode SUi and scan electrode SCi exceeds the discharge start voltage. Thus, sustain discharge occurs again between sustain electrode SUi and scan electrode SCi, negative wall voltage is accumulated on sustain electrode SUi, and positive wall voltage is accumulated on scan electrode SCi.

Hereinafter, similarly, as many sustain pulses as the number derived by multiplying the luminance weight by a predetermined luminance magnification are alternately applied to scan electrode SC1 through scan electrode SCn and sustain electrode SU1 through sustain electrode SUn. Thus, in the discharge cell having undergone address discharge in the address period, sustain discharge is caused continuously.

After generation of all sustain pulses in the sustain period, namely after generation of the final sustain pulse in the sustain period, in the state where voltage 0 (V) is applied to sustain electrode SU1 through sustain electrode SUn and data electrode D1 through data electrode Dm, an up-ramp waveform voltage is applied to scan electrode SC1 through scan electrode SCn. Here, the up-ramp waveform voltage gently increases to voltage Vr as a predetermined voltage from voltage 0 (V) that is base potential and lower than the discharge start voltage. This up-ramp waveform voltage is referred to as “erasing up-ramp voltage L3”.

Thus, in the discharge cell having undergone the sustain discharge, by continuously causing feeble discharge, a part or the whole of the wall voltages on scan electrode SCi and sustain electrode SUi is erased while the positive wall voltage is kept on data electrode Dk.

Specifically, in the state where voltage 0 (V) is applied to sustain electrode SU1 through sustain electrode SUn and data electrode D1 through data electrode Dm, erasing up-ramp voltage L3, which increases from voltage 0 (V) to voltage Vr, is generated at a gradient steeper than that of up-ramp voltage L1, and is applied to scan electrode SC1 through scan electrode SCn. This gradient is about 5 V/μsec, for example. When voltage Vr is set at a voltage exceeding the discharge start voltage, feeble discharge occurs between sustain electrode SUi and scan electrode SCi of the discharge cell having undergone the sustain discharge.

This feeble discharge continuously occurs while the voltage applied to scan electrode SC1 through scan electrode SCn increases beyond the discharge start voltage. When the increasing voltage arrives at predetermined voltage Vr, the voltage applied to scan electrode SC1 through scan electrode SCn is decreased to voltage 0 (V).

In the present exemplary embodiment, voltage Vr is set lower than voltage Vs of the sustain pulses. The reason for this is described later.

Charged particles generated by the feeble discharge are accumulated as wall charge on sustain electrode SUi and scan electrode SCi so as to reduce the voltage difference between sustain electrode SUi and scan electrode SCi. Thus, the wall voltage between scan electrode SC1 through scan electrode SCn and sustain electrode SU1 through sustain electrode SUn is reduced to the difference between the discharge start voltage and the voltage applied to scan electrode SCi, for example, about (voltage Vr−discharge start voltage). In other words, discharge caused by erasing up-ramp voltage L3 works as erasing discharge.

Then, scan electrode SC1 through scan electrode SCn are returned to voltage 0 (V). Thus, the sustain operation in the sustain period is completed.

In the initializing period of subfield SF2, voltage 0 (V), as the first voltage, is applied to data electrode D1 through data electrode Dm. Voltage Ve is applied to sustain electrode SU1 through sustain electrode SUn. The down-ramp waveform voltage (down-ramp voltage L4), which gently decreases from voltage Vi3′ (e.g. voltage 0 (V) as the base potential) lower than the discharge start voltage to negative voltage Vi4 exceeding the discharge start voltage, is applied to scan electrode SC1 through scan electrode SCn.

The gradient of down-ramp voltage L4 may be the same as that of down-ramp voltage L2. As an example, the gradient may have a numerical value of about −2.5 V/μsec.

Thus, in the discharge cell having undergone sustain discharge in the sustain period of the immediately preceding subfield (subfield SF1 in FIG. 3), feeble initializing discharge occurs. The wall voltage on scan electrode SCi and sustain electrode SUi is reduced, and the wall voltage on data electrode Dk is also adjusted to a value appropriate to the address operation.

While, in the discharge cell having undergone no sustain discharge in the sustain period of the immediately preceding subfield, initializing discharge does not occur and the wall charge at the end of the initializing period of the immediately preceding subfield is kept. Thus, the initializing operation in subfield SF2 is completed.

Thus, the initializing operation in subfield SF2 is a selective initializing operation of causing initializing discharge only in the discharge cell that has undergone address discharge in the address period and has undergone sustain discharge in the sustain period in the immediately preceding subfield. Hereinafter, the period in which the selective initializing operation is performed is referred to as a selective initializing period.

In the address period and sustain period of subfield SF2, a driving voltage waveform similar to that in the address period and sustain period of subfield SF1 is applied to each electrode except for the number of generated sustain pulses. In each of subfield SF3 and later, a driving voltage waveform similar to that in subfield SF2 is applied to each electrode except for the number of generated sustain pulses.

The driving voltage waveform applied to each electrode of panel 10 when an image is displayed in the present exemplary embodiment has been described schematically.

In the present exemplary embodiment, the following voltage values are applied to respective electrodes, for example. Voltage Vi1 is 150 (V), voltage Vi2 is 350 (V), voltage Vi3 is 215 (V), voltage Vi3′ is 0 (V), voltage Vi4 is −175 (V), voltage Vc is −50 (V), voltage Va is −200 (V), voltage Vs is 215 (V), voltage Vr is 200 (V), voltage Ve is 170 (V), and voltage Vd is 60 (V). These voltage values are simply one example in the present exemplary embodiment. The voltage values are not limited to the above-mentioned values. Preferably, the voltage values are set optimally based on the characteristics of panel 10 and the specification of the plasma display apparatus.

Next, the reason why voltage Vr as the maximum voltage of erasing up-ramp voltage L3 is set lower than voltage Vs of the sustain pulses is described.

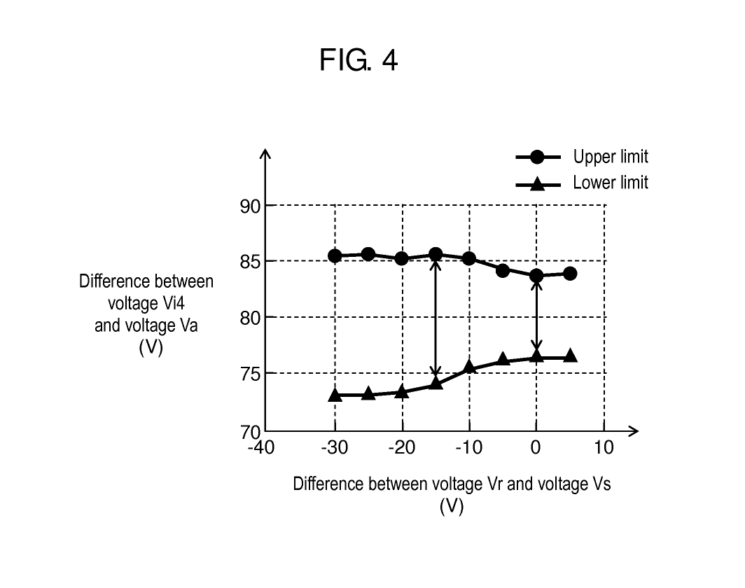

FIG. 4 is a diagram showing the relationship between the voltage difference between voltage Vr and voltage Vs and the voltage difference between voltage Vi4 and voltage Va in accordance with the first exemplary embodiment of the present invention.

The voltage difference between voltage Vi4 and voltage Va is referred to as voltage Vset2. In other words, voltage Vi4=voltage Va+voltage Vset2.

In FIG. 4, the horizontal axis shows the voltage difference between voltage Vr and voltage Vs, namely voltage Vr−voltage Vs, and the vertical axis shows the voltage difference between voltage Vi4 and voltage Va, namely voltage Vi4−voltage Va (=voltage Vset2).

In FIG. 4, the line graph with circles shows the upper limit of voltage Vset2 capable of stably causing address discharge in the subsequent address period. When voltage Vset2 is set higher than the upper limit, the possibility of causing false discharge in the subsequent address period becomes high. This false discharge means the phenomenon where address discharge occurs even in the discharge cell to which no address pulse is applied (the discharge cell to which only a scan pulse is applied).

In FIG. 4, the line graph with triangles shows the lower limit of voltage Vset2 capable of stably causing address discharge in the subsequent address period. When voltage Vset2 is set lower than the lower limit, in the subsequent address period, the possibility of causing an address failure where address discharge does not occur in the discharge cell to which an address pulse is applied becomes high.

Therefore, when the difference between the upper limit and lower limit is large, the address operation can be stably performed in the subsequent address period.

The graphs of FIG. 4 are obtained by the following experiment:
voltage Vs is set at 215 (V), voltage Va is set at −200 (V), and occurrence of discharge is recognized while voltage Vset2 is varied by varying voltage Vr from voltage Vs+5 (V) to voltage Vs−30 (V) in 5 (V) steps.

As shown in FIG. 4, when voltage Vr−voltage Vs is voltage 0 (V), namely when voltage Vr=voltage Vs, the difference between the upper limit (about 83.5 (V)) and lower limit (about 76.5 (V)) of voltage Vset2 is about 7 (V).

When voltage Vr−voltage Vs is −5 (V), namely when voltage Vr=voltage Vs−5 (V), the difference between the upper limit (about 84.1 (V)) and lower limit (about 76 (V)) of voltage Vset2 is about 8.1 (V).

When voltage Vr−voltage Vs is −10 (V), namely when voltage Vr=voltage Vs−10 (V), the difference between the upper limit (about 85.2 (V)) and lower limit (about 75.5 (V)) of voltage Vset2 is about 9.7 (V).

When voltage Vr−voltage Vs is −15 (V), namely when voltage Vr=voltage Vs−15 (V), the difference between the upper limit (about 85.5 (V)) and lower limit (about 74 (V)) of voltage Vset2 is about 11.5 (V).

When voltage Vr−voltage Vs is −20 (V), namely when voltage Vr=voltage Vs−20 (V), the difference between the upper limit (about 85.2 (V)) and lower limit (about 73.5 (V)) of voltage Vset2 is about 11.7 (V).

When voltage Vr−voltage Vs is −25 (V), namely when voltage Vr=voltage Vs−25 (V), the difference between the upper limit (about 85.5 (V)) and lower limit (about 73 (V)) of voltage Vset2 is about 12.5 (V).

When voltage Vr−voltage Vs is −30 (V), namely when voltage Vr=voltage Vs−30 (V), the difference between the upper limit (about 85.4 (V)) and lower limit (about 73 (V)) of voltage Vset2 is about 12.4 (V).

Thus, the following result can be recognized from FIG. 4:
by setting voltage Vr at a voltage lower than voltage Vs, the difference between the upper limit and lower limit of voltage Vset2 capable of stably causing address discharge in the subsequent address period is made larger than that when voltage Vr is set equal to voltage Vs, and the address operation can be stabilized.

This is considered to be because, when voltage Vr is set lower than voltage Vs, the duration of erasing discharge is made shorter, larger wall charge produced by the sustain discharge remains, and hence the discharge produced especially between scan electrodes 22 and sustain electrodes 23 is more stabilized than when voltage Vr is set equal to voltage Vs.

In the present exemplary embodiment, thus, voltage Vr is set lower than voltage Vs.

When voltage Vr−voltage Vs is −35 (V) or lower, namely when voltage Vr is (voltage Vs−35 (V)) or lower, however, it is recognized that the possibility of keeping the sustain discharge also in a discharge cell to which no address pulse is applied is high in the subsequent sustain period. This is considered to be because, by excessively decreasing voltage Vr, erasing discharge becomes insufficient, and the residues of wall charge and priming particles become excessive.

Thus, it is recognized that excessively decreasing voltage Vr can cause false discharge in the subsequent sustain period. In the present exemplary embodiment, voltage Vr is set at a voltage that is lower than voltage Vs and does not cause false discharge in the subsequent sustain period.

Specifically, in the present exemplary embodiment, voltage Vr is set in the range of voltage Vs−5 (V) to voltage Vs−30 (V) based on the characteristics of FIG. 4. For example, voltage Vs is set at 215 (V), and voltage Vr is set at 200 (v).

These voltage values are simply one example in the present exemplary embodiment. The voltage values are not limited to the above-mentioned values. Preferably, the voltage values are set optimally in response to the characteristics of panel 10 and the specification of the plasma display apparatus.

Next, the configuration of the plasma display apparatus of the present exemplary embodiment is described. In the following description, the operation of turning on a switching element is denoted as “ON”, and the operation of turning it off is denoted as “OFF”.

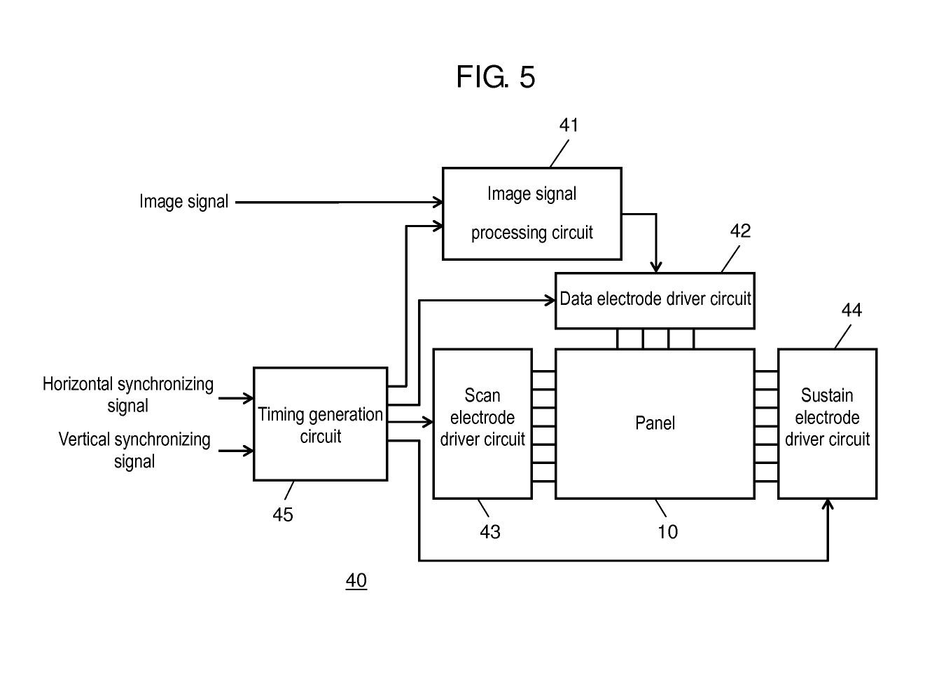

FIG. 5 is a circuit block diagram of plasma display apparatus 40 in accordance with the first exemplary embodiment of the present invention.

Plasma display apparatus 40 includes panel 10 and a driver circuit for driving panel 10. The driver circuit has the following elements:
image signal processing circuit 41;
data electrode driver circuit 42;
scan electrode driver circuit 43;
sustain electrode driver circuit 44;
timing generation circuit 45; and
a power supply circuit (not shown) for supplying power required for each circuit block.

Image signal processing circuit 41 assigns each gradation value to each discharge cell based on an input image signal. Image signal processing circuit 41 converts each gradation value into image data that indicates light emission or no light emission in each subfield.

For example, when input image signal sig includes an R signal, G signal, and B signal, image signal processing circuit 41 assigns each gradation value of R, G, and B (gradation value represented in one field) to each discharge cell based on the R signal, G signal, and B signal. When input image signal sig includes a luminance signal (Y signal) and a chroma signal (C signal, R-Y signal and B-Y signal, or u signal and v signal), image signal processing circuit 41 calculates the R signal, G signal, and B signal based on the luminance signal and chroma signal, and then assigns each gradation value of R, G, and B to each discharge cell. Then, image signal processing circuit 41 converts each gradation value of R, G, and B assigned to each discharge cell into image data that indicates light emission or no light emission in each subfield.

Timing generation circuit 45 generates various timing signals for controlling the operations of respective circuit blocks based on a horizontal synchronizing signal and vertical synchronizing signal. Timing generation circuit 45 supplies the generated timing signals to respective circuit blocks (image signal processing circuit 41, data electrode driver circuit 42, scan electrode driver circuit 43, and sustain electrode driver circuit 44).

Scan electrode driver circuit 43 has an initializing waveform generation circuit, a sustain pulse generation circuit, and a scan pulse generation circuit (not shown). The initializing waveform generation circuit generates initializing waveforms to be applied to scan electrode SC1 through scan electrode SCn in the initializing period. The sustain pulse generation circuit generates sustain pulses to be applied to scan electrode SC1 through scan electrode SCn in the sustain period. The scan pulse generation circuit has a plurality of scan electrode driver integrated circuits (scan ICs), and generates scan pulses to be applied to scan electrode SC1 through scan electrode SCn in the address period. Scan electrode driver circuit 43 drives each of scan electrode SC1 through scan electrode SCn based on a timing signal supplied from timing generation circuit 45.

Data electrode driver circuit 42 converts data for each of the subfields constituting image data into address pulses corresponding to data electrode D1 through data electrode Dm. Then, data electrode driver circuit 42 applies the address pulses to data electrode D1 through data electrode Dm based on the timing signal supplied from timing generation circuit 45.

Sustain electrode driver circuit 44 has a sustain pulse generation circuit and a circuit (not shown) for generating voltage Ve. Sustain electrode driver circuit 44 drives sustain electrode SU1 through sustain electrode SUn based on the timing signal supplied from timing generation circuit 45.

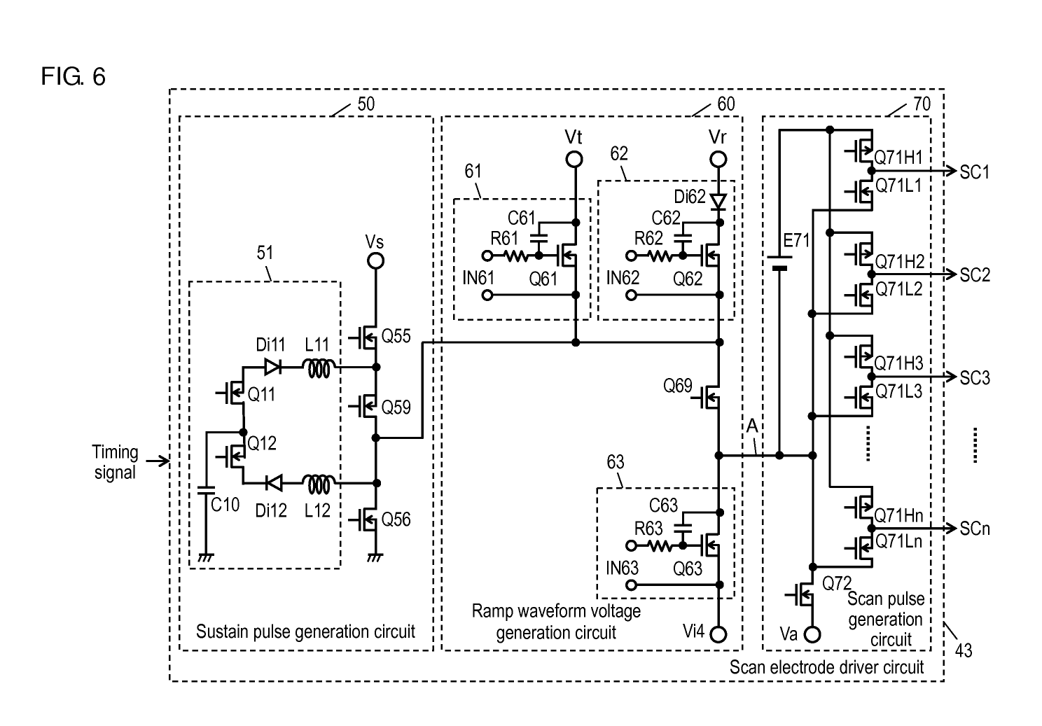

FIG. 6 is a circuit diagram for schematically showing the configuration of scan electrode driver circuit 43 of plasma display apparatus 40 in accordance with the first exemplary embodiment of the present invention.

Scan electrode driver circuit 43 includes sustain pulse generation circuit 50, ramp waveform voltage generation circuit 60, and scan pulse generation circuit 70. Each circuit block works based on the timing signal supplied from timing generation circuit 45, but the details of the path of the timing signal are omitted in FIG. 6. The voltage input to scan pulse generation circuit 70 is denoted as “reference potential A”.

Sustain pulse generation circuit 50 includes power recovery circuit 51, switching element Q55, switching element Q56, and switching element Q59. Power recovery circuit 51 includes capacitor C10 for power recovery, switching element Q11, switching element Q12, diode Di11 and diode Di12 for back flow prevention, and inductor L11 and inductor L12 for resonance.

Power recovery circuit 51 recovers, from panel 10, the electric power accumulated in panel 10 by LC resonance of the inter-electrode capacity of panel 10 and inductor L12, and accumulates it in capacitor C10. Power recovery circuit 51 supplies the recovered electric power from capacitor C10 to panel 10 again by LC resonance of the inter-electrode capacity of panel 10 and inductor L11, and reuses it as electric power for driving scan electrode SC1 through scan electrode SCn.

Switching element Q55 clamps scan electrode SC1 through scan electrode SCn on voltage Vs, and switching element Q56 clamps scan electrode SC1 through scan electrode SCn on voltage 0 (v). Switching element Q59 is a separation switch and prevents current from flowing back via a parasitic diode or the like of a switching element constituting scan electrode driver circuit 43.

Sustain pulse generation circuit 50 thus generates sustain pulses of voltage Vs to be applied to scan electrode SC1 through scan electrode SCn.

Scan pulse generation circuit 70 has switching element Q71H1 through switching element Q71Hn, switching element Q71L1 through switching element Q71Ln, switching element Q72, a power supply for generating negative voltage Va, and power supply E71 for generating voltage Vp. Then, voltage Vc (Va+Vp) is generated by adding voltage Vp to reference potential A of scan pulse generation circuit 70, and voltage Va and voltage Vc are applied to scan electrode SC1 through scan electrode SCn while switching between voltage Va and voltage Vc is performed, thereby generating scan pulses. For example, when voltage Va is −200 (V) and voltage Vp is 150 (V), voltage Vc becomes −50 (V).

Scan pulse generation circuit 70 sequentially applies scan pulses to scan electrode SC1 through scan electrode SCn at timings of FIG. 3. Scan pulse generation circuit 70 outputs the output voltage of sustain pulse generation circuit 50 in the sustain period as it is. In other words, the voltage of reference potential A is output to scan electrode SC1 through scan electrode SCn.

Ramp waveform voltage generation circuit 60 includes Miller integrating circuit 61, Miller integrating circuit 62, and Miller integrating circuit 63, and generates the ramp waveform voltage of FIG. 3.

Miller integrating circuit 61 has transistor Q61, capacitor C61, and resistor R61. Miller integrating circuit 61 generates an up-ramp waveform voltage that gently increases to voltage Vt by applying a fixed voltage to input terminal IN61 (applying a fixed voltage difference between two circles shown as input terminal IN61).

In the present exemplary embodiment, voltage Vi2 is set equal to a voltage derived by adding voltage Vp to voltage Vt. In other words, when Miller integrating circuit 61 is operated, switching element Q72 and switching element Q71L1 through switching element Q71Ln are set at OFF, and switching element Q71H1 through switching element Q71Hn are set at ON. Thus, up-ramp voltage L1 is generated by adding voltage Vp of power supply E71 to the up-ramp waveform voltage generated by Miller integrating circuit 61.

Miller integrating circuit 62 includes transistor Q62, capacitor C62, resistor R62, and diode D162 for back flow prevention. Miller integrating circuit 62 generates an up-ramp waveform voltage (erasing up-ramp voltage L3), which gently increases to voltage Vr, by applying a fixed voltage to input terminal IN62 (applying a fixed voltage difference between two circles shown as input terminal IN62).

Miller integrating circuit 63 includes transistor Q63, capacitor C63, and resistor R63. Miller integrating circuit 63 generates a down-ramp waveform voltage (down-ramp voltage L2 or down-ramp voltage L4), which gently decreases to voltage Vi4, by applying a fixed voltage to input terminal IN63 (applying a fixed voltage difference between two circles shown as input terminal IN63).

Switching element Q69 is a separation switch and prevents current from flowing back via a parasitic diode or the like of a switching element constituting scan electrode driver circuit 43.

These switching elements and transistors can be formed using a generally known semiconductor device such as a metal oxide semiconductor field effect transistor (MOSFET) or an insulated gate bipolar transistor (IGBT). These switching elements and transistors are controlled in response to the timing signals that are generated by timing generation circuit 45 and correspond to the switching elements and transistors.

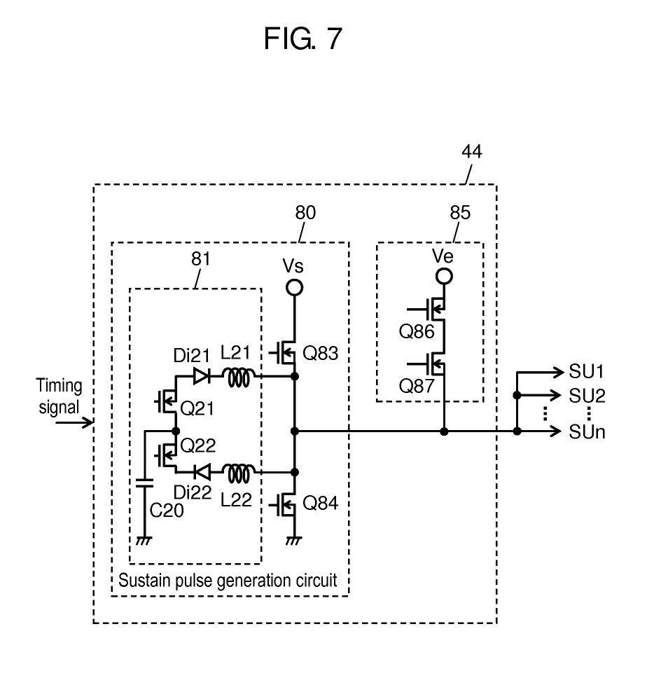

FIG. 7 is a circuit diagram for schematically showing the configuration of sustain electrode driver circuit 44 of plasma display apparatus 40 in accordance with the first exemplary embodiment of the present invention.

Sustain electrode driver circuit 44 includes sustain pulse generation circuit 80 and fixed voltage generation circuit 85. Each circuit block works based on the timing signal supplied from timing generation circuit 45, but the details of the path of the timing signal are omitted in FIG. 7.

Sustain pulse generation circuit 80 includes power recovery circuit 81, switching element Q83, and switching element Q84. Power recovery circuit 81 includes capacitor C20 for power recovery, switching element Q21, switching element Q22, diode D121 and diode D122 for back flow prevention, and inductor L21 and inductor L22 for resonance.

Power recovery circuit 81 recovers, from panel 10, the electric power accumulated in panel 10 by LC resonance of the inter-electrode capacity of panel 10 and inductor L22, and accumulates it in capacitor C20. Power recovery circuit 81 supplies the recovered electric power from capacitor C20 to panel 10 again by LC resonance of the inter-electrode capacity of panel 10 and inductor L21, and reuses it as electric power for driving sustain electrode SU1 through sustain electrode SUn.

Switching element Q83 clamps sustain electrode SU1 through sustain electrode SUn on voltage Vs, and switching element Q84 clamps sustain electrode SU1 through sustain electrode SUn on voltage 0 (V).

Sustain pulse generation circuit 80 thus generates sustain pulses of voltage Vs to be applied to scan electrode SC1 through scan electrode SCn.

Fixed voltage generation circuit 85 includes switching element Q86 and switching element Q87. Fixed voltage generation circuit 85 applies voltage Ve to sustain electrode SU1 through sustain electrode SUn.

These switching elements can be formed using a generally known element such as a MOSFET or IGBT. These switching elements are controlled in response to the timing signals that are generated by timing generation circuit 45 and correspond to the respective switching elements.

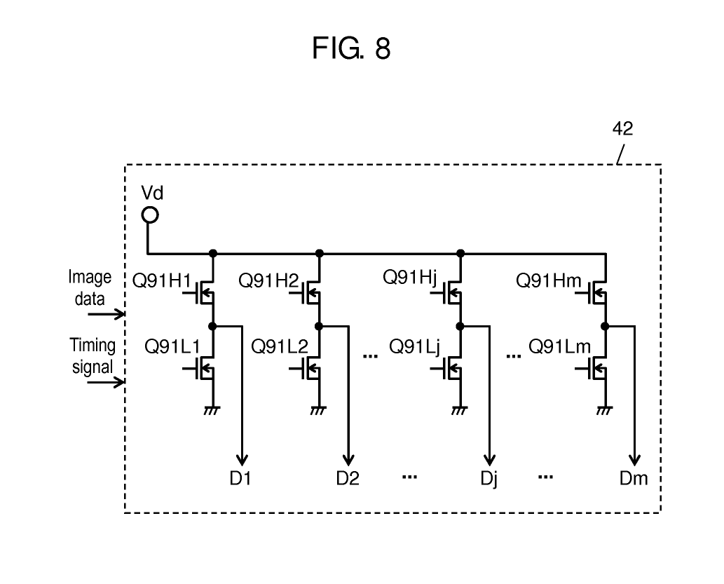

FIG. 8 is a circuit diagram for schematically showing the configuration of data electrode driver circuit 42 of plasma display apparatus 40 in accordance with the first exemplary embodiment of the present invention.

Data electrode driver circuit 42 works based on the image data supplied from image signal processing circuit 41 and the timing signal supplied from timing generation circuit 45, but the details of the path of these signals are omitted in FIG. 8.

Data electrode driver circuit 42 includes switching element Q91H1 through switching element Q91Hm, and switching element Q91L1 through switching element Q91Lm. Voltage 0 (V) is applied to data electrode Dj by setting switching element Q91Lj at ON, and voltage Vd is applied to data electrode Dj by setting switching element Q91Hj at ON.

In the present exemplary embodiment, thus, after generation of the final sustain pulse in the sustain period, in the state where voltage 0 (V) is applied to sustain electrode SU1 through sustain electrode SUn and data electrode D1 through data electrode Dm, the up-ramp waveform voltage (erasing up-ramp voltage L3) is applied to scan electrode SC1 through scan electrode SCn. Here, the up-ramp waveform voltage gently increases from 0 (V) lower than the discharge start voltage to voltage Vr as a predetermined voltage. Voltage Vr is set at a voltage that is lower than voltage Vs and does not cause false discharge in the subsequent address period. Thus, also when panel 10 having a high definition and large screen is driven, a stable address operation can be performed and a high-quality image can be displayed on panel 10.

The present exemplary embodiment has described the example where the first voltage is set at voltage 0 (V), but the first voltage is not limited to voltage 0 (V) in the present invention. The first voltage is set in a range capable of producing the above-mentioned effect.

### Second Exemplary Embodiment

The first exemplary embodiment has described the configuration where panel 10 is driven while the all-cell initializing operation is performed once per field. However, the present invention is not limited to this configuration. A configuration may be employed where panel 10 is driven while the all-cell initializing operation is performed once for a plurality of fields, for example. Also in this case, the effect similar to the above-mentioned one can be produced.

In the driving method where the all-cell initializing operation is performed once for a plurality of fields, the light emission caused by the all-cell initializing operation can be reduced, and the luminance of black level (luminance of the gradation causing no sustain discharge) can be reduced, and the contrast of the image displayed on panel 10 can be improved, comparing with the configuration where the all-cell initializing operation is performed once per field.

Hereinafter, the example is described where panel 10 is driven while the number of all-cell initializing operations is set at one for three fields.

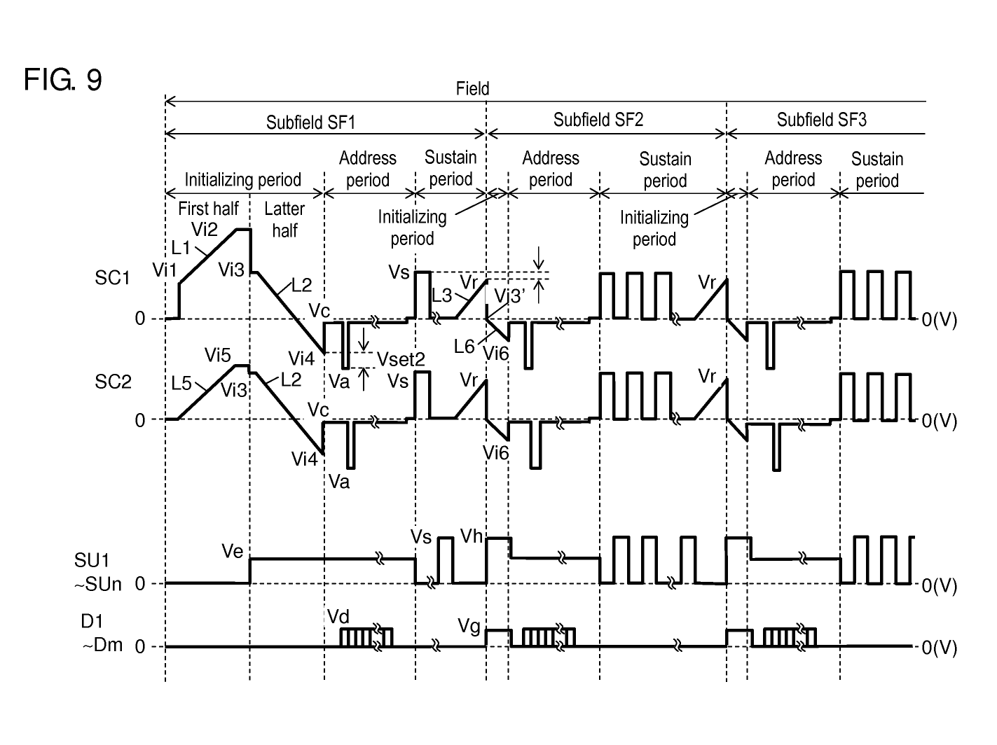

FIG. 9 is a diagram showing a driving voltage waveform that is to be applied to each electrode of panel 10 used in a plasma display apparatus in accordance with a second exemplary embodiment of the present invention.

FIG. 9 shows driving voltage waveforms applied to scan electrode SC1 for firstly undergoing an address operation in the address period, scan electrode SC2 for secondly undergoing the address operation in the address period, sustain electrode SU1 through sustain electrode SUn, and data electrode D1 through data electrode Dm.

In the present exemplary embodiment, subfield SF1 is a first-kind subfield having discharge cells where a forced initializing operation is performed and discharge cells where no forced initializing operation is performed. Subfield SF2 through subfield SF10 are second-kind subfields where a selective initializing operation is performed in all discharge cells.

The forced initializing operation is an initializing operation of forcibly causing initializing discharge in the discharge cells regardless of occurrence of address discharge (sustain discharge) in the immediately preceding subfield, and is the same as the all-cell initializing operation described in the first exemplary embodiment. Therefore, the driving voltage waveform applied to each electrode in the forced initializing operation is equal to the all-cell initializing waveform applied to each electrode in the all-cell initializing operation.

FIG. 9 shows driving voltage waveforms when the forced initializing operation is performed in the discharge cell formed on scan electrode SC1 and not the forced initializing operation but the selective initializing operation is performed in the discharge cell formed on scan electrode SC2 in the initializing period of subfield SF1.

In the first half of the initializing period of subfield SF1 as the first-kind subfield, voltage 0 (V) is applied to data electrode D1 through data electrode Dm, and voltage 0 (V) is also applied to sustain electrode SU1 through sustain electrode SUn. To scan electrode SC1 to undergo the forced initializing operation, a driving voltage waveform similar to the all-cell initializing waveform of the first exemplary embodiment is applied.

In the discharge cell formed on scan electrode SC1, an initializing operation similar to the all-cell initializing operation of the first exemplary embodiment is performed, and initializing discharge occurs regardless of occurrence of address discharge (sustain discharge) in the immediately preceding subfield.

To scan electrode SC2 to undergo no forced initializing operation, the up-ramp waveform voltage (up-ramp voltage L5), which gently increases from voltage 0 (V) to voltage Vi5 lower than voltage Vi2, is applied. By setting voltage Vi5 at a voltage lower than the discharge start voltage, initializing discharge does not occur in the discharge cell formed on scan electrode SC2.

Thus, in the first half of the initializing period of subfield SF1, the up-ramp waveform voltage (up-ramp voltage L1), which gently increases to voltage Vi2 at which discharge occurs regardless of occurrence of address discharge (sustain discharge) in the immediately preceding subfield, is applied to scan electrode 22 (e.g. scan electrode SC1) in which the forced initializing operation is performed. The up-ramp waveform voltage (up-ramp voltage L5), which gently increases to voltage Vi5 lower than voltage Vi2, is applied to scan electrode 22 (e.g. scan electrode SC2) in which the forced initializing operation is not performed.

In the latter half of the initializing period of subfield SF1, a driving voltage waveform similar to that in the latter half of the all-cell initializing period of the first exemplary embodiment is applied to each electrode. At this time, the driving voltage waveform to be applied to scan electrode 22 to undergo the forced initializing operation and the driving voltage waveform to be applied to scan electrode 22 to undergo no forced initializing operation have substantially the same shape.

Thus, feeble initializing discharge occurs in the discharge cell having undergone the forced initializing operation (for example, discharge cell formed on scan electrode SC1).

While, in the discharge cell having undergone no forced initializing operation (for example, discharge cell formed on scan electrode SC2), feeble initializing discharge occurs only in the discharge cell having undergone address discharge (sustain discharge) in the immediately preceding subfield. Here, the immediately preceding subfield is the final subfield (e.g. subfield SF10) of the immediately preceding field. In the discharge cell having undergone no address discharge (sustain discharge) in the immediately preceding subfield, initializing discharge does not occur, but the wall voltage is kept as it is.

Therefore, the initializing operation to be performed in the discharge cell where the forced initializing operation is not performed is a selective initializing operation.

Thus, in the first-kind subfield (subfield SF1), there are discharge cells where the forced initializing operation is performed and discharge cells where the selective initializing operation is performed in the initializing period.

An initializing waveform having the same shape as that of the all-cell initializing waveform is applied to scan electrode 22 of the discharge cell to undergo the forced initializing operation. In other words, up-ramp voltage L1 and down-ramp voltage L2 are applied to scan electrode 22 of the discharge cell to undergo the forced initializing operation. Up-ramp voltage L1 is an up-ramp waveform voltage that increases to voltage Vi2 at which initializing discharge occurs in the discharge cell regardless of occurrence of address discharge (sustain discharge) in the immediately preceding subfield. Down-ramp voltage L2 is a down-ramp waveform voltage that decreases to voltage Vi4 at which discharge occurs.

Up-ramp voltage L5 and down-ramp voltage L2 are applied to scan electrode 22 of the discharge cell to undergo no forced initializing operation. Up-ramp voltage L5 is an up-ramp waveform voltage that increases to voltage Vi5 that is lower than voltage Vi2 and does not cause initializing discharge. Down-ramp voltage L2 is a down-ramp waveform voltage that decreases to voltage Vi4.

Hereinafter, the period in which the forced initializing operation is performed is referred to as “forced initializing period”. The driving voltage waveform generated for performing the forced initializing operation is referred to as “forced initializing waveform”.

The operation in the subsequent address period and sustain period of subfield SF1 is the same as that in the first exemplary embodiment.

After generation of the final sustain pulse in the sustain period, in the state where voltage 0 (V) is applied to sustain electrode SU1 through sustain electrode SUn and data electrode D1 through data electrode Dm, the up-ramp waveform voltage (erasing up-ramp voltage L3) is applied to scan electrode SC1 through scan electrode SCn. Here, the up-ramp waveform voltage gently increases from voltage 0 (V) lower than the discharge start voltage to voltage Vr as a predetermined voltage. Voltage Vr is set at a voltage that is lower than voltage Vs and does not cause false discharge in the subsequent address period.

Subsequent subfield SF2, which is the selective initializing subfield, is a second-kind subfield in which the selective initializing operation is performed in all discharge cells in the initializing period.

In the initializing period (selective initializing period) of subfield SF2, a driving voltage waveform similar to that in the selective initializing period of the first exemplary embodiment may be applied to each electrode. However, the lowest voltage of the down-ramp waveform voltage to be applied to scan electrode SC1 through scan electrode SCn may be set higher than voltage Vi4 as the lowest voltage of down-ramp voltage L2.

The present exemplary embodiment describes an example where, in the selective initializing period, the lowest voltage of the down-ramp waveform voltage to be applied to scan electrode SC1 through scan electrode SCn is set at voltage Vi6 higher than voltage Vi4, and the second down-ramp waveform voltage (hereinafter referred to as “down-ramp voltage L6”), which decreases from voltage Vi3′ to voltage Vi6, is applied to scan electrode SC1 through scan electrode SCn.

In the initializing period of subfield SF2, voltage Vh higher than voltage Ve is applied to sustain electrode SU1 through sustain electrode SUn. The down-ramp waveform voltage (down-ramp voltage L6), which gently decreases from voltage Vi3′ (e.g. voltage 0 (V)) lower than the discharge start voltage to negative voltage Vi6 exceeding the discharge start voltage, is applied to scan electrode SC1 through scan electrode SCn.

The gradient of down-ramp voltage L6 may be the same as that of down-ramp voltage L2. As an example, the gradient may have a numerical value of about −2.5 V/μsec.

In the period when down-ramp voltage L6 is applied to scan electrode SC1 through scan electrode SCn, the second voltage (positive voltage Vg) having a voltage value higher than that of the first voltage (voltage 0 (V)) is applied to data electrode D1 through data electrode Dm.

Voltage Vi6 as the lowest voltage of down-ramp voltage L6, as discussed above, is set at a voltage that is higher than voltage Vi4 as the lowest voltage of down-ramp voltage L2 and causes discharge only in the discharge cell having undergone address discharge (sustain discharge) in the immediately preceding subfield. At this time, preferably, voltage Vi6 is set so that the differential voltage (voltage applied to the discharge cell) between voltage Vg and voltage Vi6 is equivalent to voltage Vi4.

The operation in the subsequent address period and sustain period of subfield SF2 is the same as that in the first exemplary embodiment.

In other words, after generation of the final sustain pulse in the sustain period, in the state where voltage 0 (V) is applied to sustain electrode SU1 through sustain electrode SUn and data electrode D1 through data electrode Dm, the up-ramp waveform voltage (erasing up-ramp voltage L3) is applied to scan electrode SC1 through scan electrode SCn. Here, the up-ramp waveform voltage gently increases from voltage 0 (V) lower than the discharge start voltage to voltage Vr as a predetermined voltage. Voltage Vr is set at a voltage that is lower than voltage Vs and does not cause false discharge in the subsequent address period.

In each of subfield SF3 and later, a driving voltage waveform similar to that in subfield SF2 is applied to each electrode except for the number of generated sustain pulses.

In the present exemplary embodiment, the following voltage values are applied to respective electrodes, for example. Voltage Vi1 is 150 (V), voltage Vi2 is 350 (V), voltage Vi3 is 215 (V), voltage Vi3′ is 0 (V), voltage Vi4 is −175 (V), voltage Vi5 is 200 (V), voltage Vi6 is −120 (V), voltage Vc is −50 (V), voltage Va is −200 (V), voltage Vs is 215 (V), voltage Vr is 200 (V), voltage Ve is 170 (V), voltage Vd is 55 (V), voltage Vh is 215 (V), and voltage Vg is 55 (V). These voltage values are simply one example in the present exemplary embodiment. The voltage values are not limited to the above-mentioned values. Preferably, the voltage values are set optimally based on the characteristics of panel 10 and the specification of the plasma display apparatus.

Next, the relationship between a field and scan electrode 22 to which a forced initializing waveform is applied is described.

In the present exemplary embodiment, scan electrode 22 to which the forced initializing waveform is applied is set for each field based on the following rules.

In other words, N (N is a natural number) temporally continuous fields are set as one field group, and N sequentially disposed scan electrodes 22 are set as one scan electrode group. For example, three temporally continuous fields are set as one field group, and three sequentially disposed scan electrodes 22 are set as one scan electrode group.

To each of scan electrodes 22 constituting one scan electrode group, the forced initializing waveform is applied once per field group.

In each of the fields constituting one field group, the forced initializing waveform is applied to only one scan electrode 22 of each scan electrode group. Therefore, for example, when the number of scan electrodes 22 is 1080 and the number of scan electrode groups is 360, the number of scan electrodes 22 to which the forced initializing waveform is applied in one field is 360. Then, the forced initializing waveform is applied to 360 other scan electrodes 22 in the next field, and the forced initializing waveform is applied to 360 remaining scan electrodes 22 in the third field.

Then, scan electrodes 22 to which the forced initializing waveform is applied are set so that the forced initializing waveform is not applied to scan electrodes 22 adjacent to scan electrodes 22 to which the forced initializing waveform is applied.

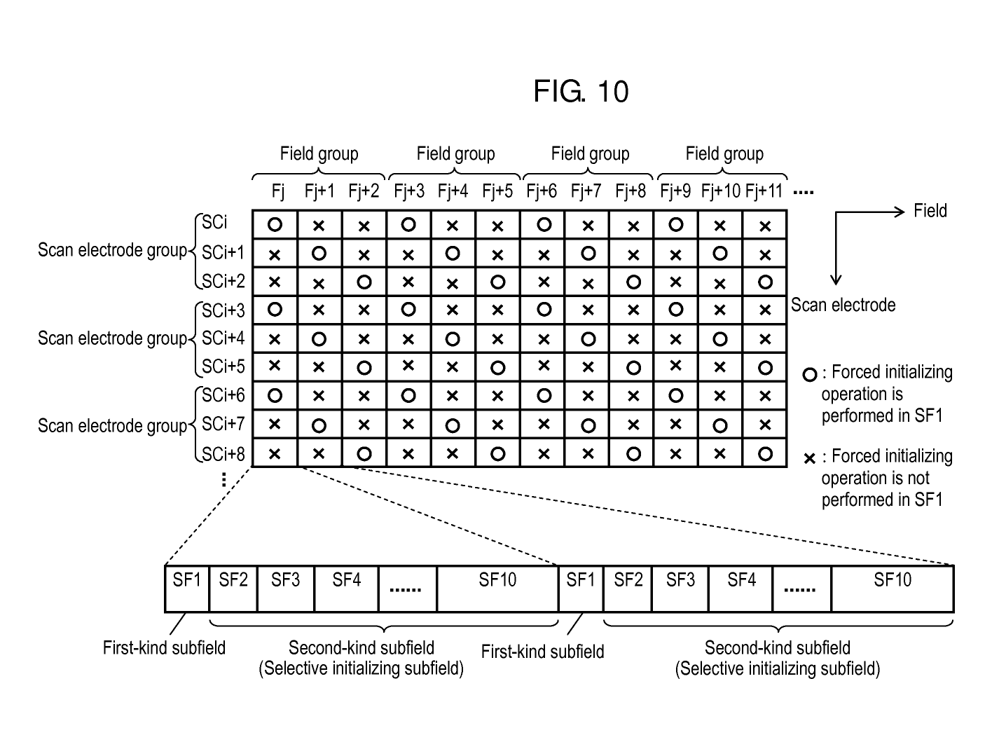

FIG. 10 is a diagram for schematically showing the relationship between the fields and scan electrodes 22 to which a forced initializing waveform is applied in accordance with the second exemplary embodiment of the present invention.

In FIG. 10, the horizontal meshes show fields, and the vertical meshes show scan electrodes 22. FIG. 10 shows the example of N=3, namely the example where three temporally continuous fields constitute one field group, and three sequentially disposed scan electrodes 22 constitute one scan electrode group.

In FIG. 10, respective field groups are constituted by field Fj through field Fj+2, field Fj+3 through field Fj+5, field Fj+6 through field Fj+8, and field Fj+9 through field Fj+11. Respective scan electrode groups are constituted by scan electrode SCi through scan electrode SCi+2, scan electrode SCi+3 through scan electrode SCi+5, and scan electrode SCi+6 through scan electrode SCi+8.

In FIG. 10, “O” indicates that the forced initializing operation is performed in the initializing period of subfield SF1. In other words, “O” indicates that a forced initializing waveform having up-ramp voltage L1 and down-ramp voltage L2 is applied to scan electrodes 22 in the initializing period of subfield SF1. “x” indicates that the forced initializing operation is not performed in the initializing period of subfield SF1. In other words, “x” indicates that an initializing waveform having up-ramp voltage L5 and down-ramp voltage L2 is applied to scan electrodes 22 in the initializing period of subfield SF1.

As is clear from FIG. 10, to each of scan electrodes 22 constituting one scan electrode group, the forced initializing waveform is applied once in one field group.

For example, to scan electrode SCi, the forced initializing waveform is applied in each of field Fj, field Fj+3, field Fj+6, field Fj+9, and others. This operation is performed also in other scan electrodes 22.

Thus, the number of forced initializing operations is reduced to ⅓ of that in the case where the forced initializing operation is performed once per field. Therefore, the number of light emissions caused by the forced initializing operation is also reduced to ⅓, and the luminance of black level of a display image is also reduced correspondingly.

In each of the fields constituting one field group, the forced initializing waveform is applied to only one scan electrode 22 of each scan electrode group.

In field Fj, for example, the forced initializing waveform is applied to scan electrode SCi, scan electrode SCi+3, scan electrode SCi+6, and others. In field Fj+1, the forced initializing waveform is applied to scan electrode SCi+1, scan electrode SCi+4, scan electrode SCi+7, and others. In field Fj+2, the forced initializing waveform is applied to scan electrode SCi+2, scan electrode SCi+5, scan electrode SCi+8, and others. This operation is performed in the other fields.

Thus, scan electrodes 22 to which the forced initializing waveform is applied can be dispersed in respective fields, so that flicker (fluctuation in a display image) can be reduced.

The forced initializing waveform is not applied to scan electrodes 22 adjacent to scan electrodes 22 to which the forced initializing waveform is applied.

In field Fj, for example, the forced initializing waveform is applied to scan electrode SCi+3, and the forced initializing waveform is not applied to scan electrode SCi+2 and scan electrode SCi+4 that are adjacent to scan electrode SCi+3. This operation is performed in the other scan electrodes 22.

Thus, the temporal and spatial continuity of scan electrodes 22 to which the forced initializing waveform is applied can be reduced, so that the light emission by the forced initializing operation can be hardly recognized by a user.

In the present exemplary embodiment, the forced initializing operation is performed only in one of a plurality of continuous fields in each discharge cell. Thus, the number of forced initializing operations is set at one for a plurality of fields, the light emission that is caused by the forced initializing operation and is not related to gradation display is reduced to decrease the luminance of black level, and a high-contrast image can be displayed on panel 10.

The forced initializing operation has a function of accumulating wall charge required for causing address discharge in the subsequent address period. The forced initializing operation further has a function of generating priming particles required for shortening the discharge delay time and stably causing the address discharge.

When the number of forced initializing operations is simply reduced, in the subsequent address period, the possibility of causing an address failure where address discharge does not occur in the discharge cell to which an address pulse has been applied becomes high. Alternatively, the possibility that the discharge delay time of the address discharge becomes excessively long and the address operation becomes unstable becomes high. Thus, there is the possibility that an image cannot be normally displayed.

In the present exemplary embodiment, however, the second voltage (voltage Vg) higher than the first voltage (voltage 0 (V)) is applied to data electrode D1 through data electrode Dm in the initializing period of the second-kind subfields (e.g. subfield SF2 through subfield SF10) where a selective initializing operation is performed.

The lowest voltage (voltage Vi6) of the down-ramp waveform voltage (down-ramp voltage L6) to be applied to scan electrode SC1 through scan electrode SCn is set higher than the lowest voltage (voltage Vi4) of the down-ramp waveform voltage (down-ramp voltage L2) to be applied to scan electrode SC1 through scan electrode SCn in the initializing period of subfield SF1 as the first-kind subfield.

Thus, address discharge can be stably caused also in the driving method in the present exemplary embodiment where the number of forced initializing operations is reduced. The reason for this is described below.

First, the reason why positive voltage Vg is not applied to data electrode D1 through data electrode Dm in the initializing period of the first-kind subfield (subfield SF1) is described.

There is a discharge cell where the forced initializing operation is performed in the initializing period of the first-kind subfield (subfield SF1). In other words, in the first half of the initializing period, there is a discharge cell to which the up-ramp waveform voltage (up-ramp voltage L1) is applied, the up-ramp waveform voltage (up-ramp voltage L1) increases to voltage Vi2 at which discharge occurs regardless of occurrence of address discharge (sustain discharge) in the immediately preceding subfield, and initializing discharge is caused forcibly in the discharge cell.

Wall voltage of high positive polarity is accumulated on data electrode 32 of such a discharge cell. When positive voltage Vg is further applied to data electrode D1 through data electrode Dm in the discharge cell where wall voltage of high positive polarity is accumulated on data electrode 32, voltage difference between scan electrode 22 and data electrode 32 becomes excessively large, and the possibility that strong discharge occurs in the latter half of the initializing period becomes high. When strong discharge occurs in the latter half of the initializing period, wall charge and priming particles become excessive in the discharge cell, and the possibility that false discharge occurs in the subsequent address period becomes high.

In the present exemplary embodiment, in order to prevent such a phenomenon from occurring, positive voltage Vg is not applied to data electrode 32 in the initializing period of the first-kind subfield (subfield SF1) having a discharge cell to perform the forced initializing operation.

When the number of forced initializing operations is reduced, fluctuation in wall voltage of each discharge cell can become large.

In the discharge cell where the wall voltage on data electrode 32 is decreased, discharge hardly occurs between scan electrode 22 and data electrode 32, and initializing discharge hardly occurs.

However, the inventor has experimentally obtained the following result:
by applying positive voltage to data electrode D1 through data electrode Dm when the selective initializing operation is performed, initializing discharge can be stably caused in the discharge cell to perform the selective initializing operation, and the wall voltage on data electrode Dk can be made constant accurately.
   This is because the discharge between scan electrode 22 and data electrode 32 is apt to occur stably by applying positive voltage to data electrode D1 through data electrode Dm.

In the present exemplary embodiment, positive voltage Vg is applied to data electrode D1 through data electrode Dm in the initializing period of the second-kind subfields (subfield SF2 through subfield SF10) where the selective initializing operation is performed.

In order that the discharge intensity of the initializing discharge occurring in the discharge cell is made equivalent to the discharge caused by down-ramp voltage L2, it is preferable to set respective voltages so that the voltage difference between voltage Vi6 and the second voltage (voltage Vg) is substantially equal to the voltage difference between voltage Vi4 and the first voltage (voltage 0 (V)). Thus, the address discharge in the address period after the forced initializing operation and the address discharge in the address period after the selective initializing operation can be set at the equivalent discharge intensity.

The purpose of applying voltage Vh higher than voltage Ve to sustain electrode SU1 through sustain electrode SUn is to prevent that setting voltage Vi6 higher than voltage Vi4 disturbs discharge between scan electrode 22 and sustain electrode 23.

In the present exemplary embodiment, by accurately adjusting the wall voltage on data electrode Dk in that manner, address discharge can be stably caused while the number of forced initializing operations is reduced.

Next, the operation from the first-kind subfield (subfield SF1) to the second-kind subfield (subfield SF2) in the circuit for generating the driving voltage waveforms of the present exemplary embodiment is described.

The configurations of the scan electrode driver circuit, sustain electrode driver circuit, and data electrode driver circuit used in the present exemplary embodiment are the same as those of scan electrode driver circuit 43, sustain electrode driver circuit 44, and data electrode driver circuit 42 described in the first exemplary embodiment. Therefore, the descriptions of the configuration of each circuit are omitted.

In the present exemplary embodiment, in the driving voltage waveforms of FIG. 9, voltage Vi1 is set equal to voltage Vp, voltage Vi2 is set equal to voltage (Vt+Vp), voltage Vi3 is set equal to voltage Vs, and voltage Vc is set equal to voltage (Va+Vp). This setting is similar to that in the driving voltage waveforms of FIG. 3.

In the driving voltage waveforms of FIG. 9, voltage Vi5 is set equal to voltage Vt, voltage Vg is set equal to voltage Vd, and voltage Vh is set equal to voltage Vs. However, these voltages are not limited to the above-mentioned numerical values. These voltages are set optimally in response to the characteristics of panel 10 and the specification of the plasma display apparatus.

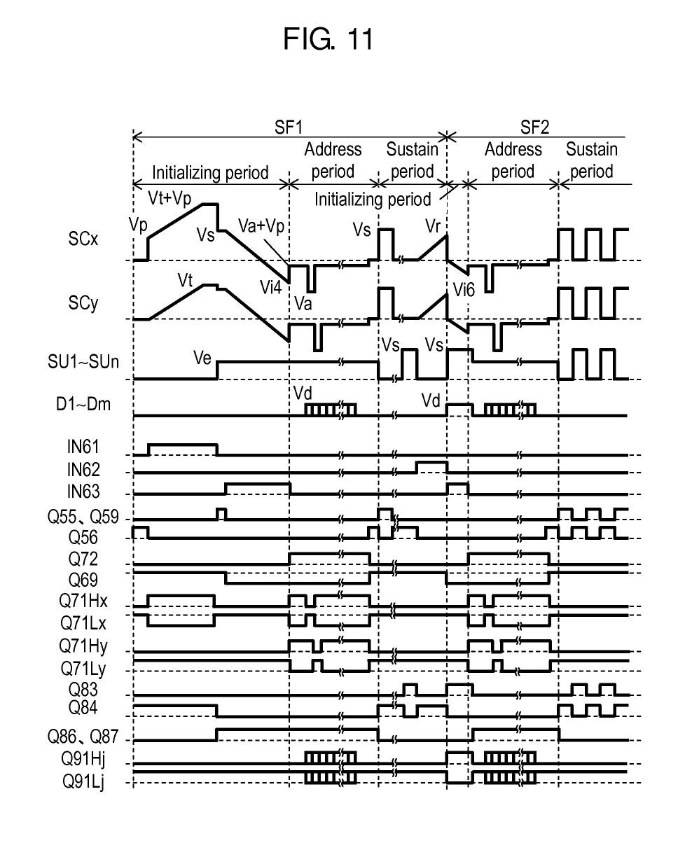

FIG. 11 is a timing chart for illustrating the operation of the driver circuits of the plasma display apparatus in accordance with the second exemplary embodiment of the present invention.

In FIG. 11, of scan electrode SC1 through scan electrode SCn, scan electrode 22 to which a forced initializing waveform is applied is set as scan electrode SCx, and scan electrode 22 to which a forced initializing waveform is not applied is set as scan electrode SCy.

In FIG. 11, of switching element Q71H1 through switching element Q71Hn, the switching element corresponding to scan electrode SCx is set as switching element Q71Hx, and the switching element corresponding to scan electrode SCy is set as switching element Q71Hy. Similarly, of switching element Q71L1 through switching element Q71Ln, the switching element corresponding to scan electrode SCx is set as switching element Q71Lx, and the switching element corresponding to scan electrode SCy is set as switching element Q71Ly.

In the first half of the initializing period of subfield SF1, firstly, switching element Q56 of scan electrode driver circuit 43 is set at ON, thereby applying voltage 0 (V) to scan electrode SCx and scan electrode SCy.

Next, switching element Q56 is set at OFF, switching element Q71Lx is set at OFF, and switching element Q71Hy is set at ON, thereby applying voltage Vp to scan electrode SCx to which a forced initializing waveform is to be applied. Voltage 0 (V) is kept to be applied to scan electrode SCy to which a forced initializing operation is not performed.

Next, a fixed voltage is applied to input terminal IN61 of Miller integrating circuit 61, and the voltage of reference potential A is increased gently to voltage Vt. Voltage derived by adding voltage Vp to reference potential A is applied to scan electrode SCx to which a forced initializing waveform is to be applied, so that the up-ramp waveform voltage (up-ramp voltage L1), which gently increases from voltage Vp to voltage (Vt+Vp), can be applied to scan electrode SCx.

While, reference potential A is applied to scan electrode SCy to which no forced initializing waveform is to be applied, so that the up-ramp waveform voltage (up-ramp voltage L5), which gently increases from voltage 0 (V) to voltage Vt, can be applied to scan electrode SCy.

In the subsequent latter half of the initializing period of subfield SF1, switching element Q84 of sustain electrode driver circuit 44 is set at OFF, and switching element Q86 and switching element Q87 are set at ON, thereby applying voltage Ve to sustain electrode SU1 through sustain electrode SUn.

Switching element Q71Hx of scan electrode driver circuit 43 is set at OFF, switching element Q71Lx is set at ON, switching element Q55 and switching element Q59 are set at ON, thereby applying voltage Vs to scan electrode SCx and scan electrode SCy.

Then, switching element Q69 is set at OFF, a fixed voltage is applied to input terminal IN63 of Miller integrating circuit 63, thereby operating Miller integrating circuit 63. The down-ramp waveform voltage (down-ramp voltage L2), which gently decreases from voltage Vi3 to voltage Vi4, is applied to scan electrode SCx and scan electrode SCy.

In the address period of subfield SF1, transistor Q63 of Miller integrating circuit 63 of scan electrode driver circuit 43 is set at OFF, and switching element Q72 is set at ON, thereby setting the voltage of reference potential A at voltage Va. Switching element Q71Lx and switching element Q71Ly are set at OFF, switching element Q71Hx and switching element Q71Hy are set at ON, thereby applying voltage (Va+Vp), namely voltage Vc, to scan electrode SCx and scan electrode SCy.

Next, switching element Q71H1 is set at OFF and switching element Q71L1 is set at ON, thereby applying a scan pulse that varies from voltage Vc to voltage Va to scan electrode SC1.

Switching element Q91L1 through switching element Q91Lm of data electrode driver circuit 42 are set at ON, and switching element Q91H1 through switching element Q91Hm are set at OFF, thereby applying voltage 0 (V) to data electrode D1 through data electrode Dm.

With a timing when a scan pulse is applied to scan electrode SC1, switching element Q91Lj is set at OFF and switching element Q91Hj is set at ON based on the image data, thereby applying an address pulse varying from voltage 0 (V) to voltage Vd to data electrode Dj to which the address pulse is to be applied.

After a certain time (after the completion of the address operation in the first row), switching element Q71H1 is set at ON and switching element Q71L1 is set at OFF, thereby returning the voltage applied to scan electrode SC1 to voltage Vc. Simultaneously, switching element Q91Lj is set at ON and switching element Q91Hj is set at OFF, thereby returning the voltage applied to data electrode Dj to voltage 0 (V). Thus, a scan pulse is applied to scan electrode SC1, and an address pulse is applied to data electrode Dj.

Subsequently, an operation similar to the above-mentioned one is performed in scan electrode SC2, a scan pulse is applied to scan electrode SC2, and an address pulse is applied to data electrode Dj.

FIG. 11 describes an example where a scan pulse is applied to scan electrode SCx, and then a scan pulse is applied to scan electrode SCy.

Hereinafter, similarly, scan pulses are sequentially applied to scan electrodes 22 until scan electrode SCn, and an address pulse is applied to data electrode Dj.

Then, switching element Q72, switching element Q71Hx, and switching element Q71Hy are set at OFF, and switching element Q56, switching element Q69, switching element Q71Lx, and switching element Q71Ly are set at ON, thereby applying voltage 0 (V) to scan electrode SCx and scan electrode SCy. Thus, the address period is completed.

In the sustain period of subfield SF1, as many sustain pulses as the number corresponding to the luminance weight are applied to scan electrode SC1 through scan electrode SCn and sustain electrode SU1 through sustain electrode SUn using sustain pulse generation circuit 50 of scan electrode driver circuit 43 and sustain pulse generation circuit 80 of sustain electrode driver circuit 44.

After generation of all sustain pulses in the sustain period, switching element Q56 of scan electrode driver circuit 43 is set at OFF. Furthermore, a fixed voltage is applied to input terminal IN62 of Miller integrating circuit 62 to operate Miller integrating circuit 62, and an up-ramp waveform voltage, which gently increases to voltage Vr, is applied to scan electrode SC1 through scan electrode SCn. Voltage Vr is lower than voltage Vs (for example, voltage Vr=voltage Vs−15 (V)).

In the initializing period of subfield SF2, switching element Q91L1 through switching element Q91Lm of data electrode driver circuit 42 are set at OFF, and switching element Q91H1 through switching element Q91Hm are set at ON, thereby applying positive voltage Vd, namely voltage Vg, to data electrode D1 through data electrode Dm.

Switching element Q84 of sustain electrode driver circuit 44 is set at OFF, switching element Q83 is set at ON, thereby applying voltage Vs, namely voltage Vh, to sustain electrode SU1 through sustain electrode SUn.

Then, a fixed voltage is applied to input terminal IN63 of Miller integrating circuit 63 in a state where switching element Q71L1 through switching element Q71Ln of scan electrode driver circuit 43 are set at ON and switching element Q71H1 through switching element Q71Hn are set at OFF. Thus, Miller integrating circuit 63 is operated, and a down-ramp waveform voltage is applied to scan electrode SC1 through scan electrode SCn.

After the down-ramp waveform voltage applied to scan electrode SC1 through scan electrode SCn arrives at voltage Vi6, the applying the voltage to input terminal IN63 is stopped. Thus, the down-ramp waveform voltage (down-ramp voltage L6), which gently decreases from voltage Vi3′ (e.g. voltage 0 (V)) to voltage Vi6, is applied to scan electrode SC1 through scan electrode SCn.

The operation in the subsequent address period and sustain period of subfield SF2 is the same as that of subfield SF1.

Thus, in the present exemplary embodiment, the driving voltage waveforms of FIG. 9 are generated using data electrode driver circuit 42, scan electrode driver circuit 43, and sustain electrode driver circuit 44, and are applied to data electrode D1 through data electrode Dm, scan electrode SC1 through scan electrode SCn, and sustain electrode SU1 through sustain electrode SUn, respectively.

In the initializing period of the first-kind subfield, a down-ramp waveform voltage is applied to scan electrodes 22 and the first voltage (voltage 0 (V)) is applied to data electrodes 32. In the initializing period of the second-kind subfield, a down-ramp waveform voltage is applied to the scan electrodes, and the second voltage (voltage Vg) higher than the first voltage is applied to the data electrodes 32. Thus, the number of forced initializing operations can be reduced, the luminance of black level can be reduced, and the address operation can be stably performed.

Thus, in the present exemplary embodiment, the number of forced initializing operations is set at one for a plurality of fields, thereby reducing the light emission that is caused by the forced initializing operation comparing with the configuration where the number of forced initializing operations is one per field. Thus, the luminance of black level (luminance of the gradation causing no sustain discharge) can be reduced, and the contrast of the image displayed on panel 10 can be improved.

Similarly to the first exemplary embodiment, after generation of the final sustain pulse in the sustain period, in the state where voltage 0 (V) is applied to sustain electrode SU1 through sustain electrode SUn and data electrode D1 through data electrode Dm, the up-ramp waveform voltage (erasing up-ramp voltage L3) is applied to scan electrode SC1 through scan electrode SCn. Here, the up-ramp waveform voltage gently increases from voltage 0 (V) lower than the discharge start voltage to voltage Vr as a predetermined voltage, Voltage Vr is set at a voltage that is lower than voltage Vs and does not cause false discharge in the subsequent address period.

Thus, also when panel 10 having a high definition and large screen is driven, a stable address operation can be performed and a high-quality image can be displayed on panel 10.

The present exemplary embodiment has described the example where the forced initializing operation is performed once for three fields in each discharge cell. However, the present invention is not limited to this configuration. Preferably, the number of forced initializing operations is set appropriately in response to the characteristics of panel 10 and the specification of the plasma display apparatus and the set value of the contrast ratio of the image displayed on panel 10.

The present exemplary embodiment has described the configuration where, in the first half of the initializing period of the first-kind subfield, up-ramp voltage L5 is applied to scan electrode 22 where the forced initializing operation is not performed. The present invention is not limited to this configuration. In the first half of the initializing period of the first-kind subfield, the voltage applied to scan electrode 22 where the forced initializing operation is not performed may be any voltage as long as discharge does not occur in the discharge cell formed on scan electrode 22. For example, the voltage may be a fixed voltage of 0 (V).

### Third Exemplary Embodiment

The first exemplary embodiment and second exemplary embodiment have described the configuration where, in all subfields, the highest voltage of erasing up-ramp voltage L3 is set at voltage Vr lower than voltage Vs. However, the present invention is not limited to this configuration. A configuration may be employed where an erasing up-ramp voltage which increases to a voltage equal to or higher than voltage Vs is generated.

The inventor has recognized the following fact:
in the final subfield of one field, an up-ramp waveform voltage which increases to a voltage equal to or higher than voltage Vs, instead of erasing up-ramp voltage L3, is applied to scan electrode SC1 through scan electrode SCn, thereby further stabilizing the address operation.

This is considered to be because, in the subfield where the number of sustain pulses generated in the sustain period is large, the wall charge and priming caused by the sustain operation becomes excessive, and hence the later operation becomes stable when the erasing operation is made relatively large.

In the third exemplary embodiment, only in the final subfield of one field, erasing up-ramp voltage L7 which increases to voltage Vr2 equal to or higher than voltage Vs is generated and is applied to scan electrode SC1 through scan electrode SCn.

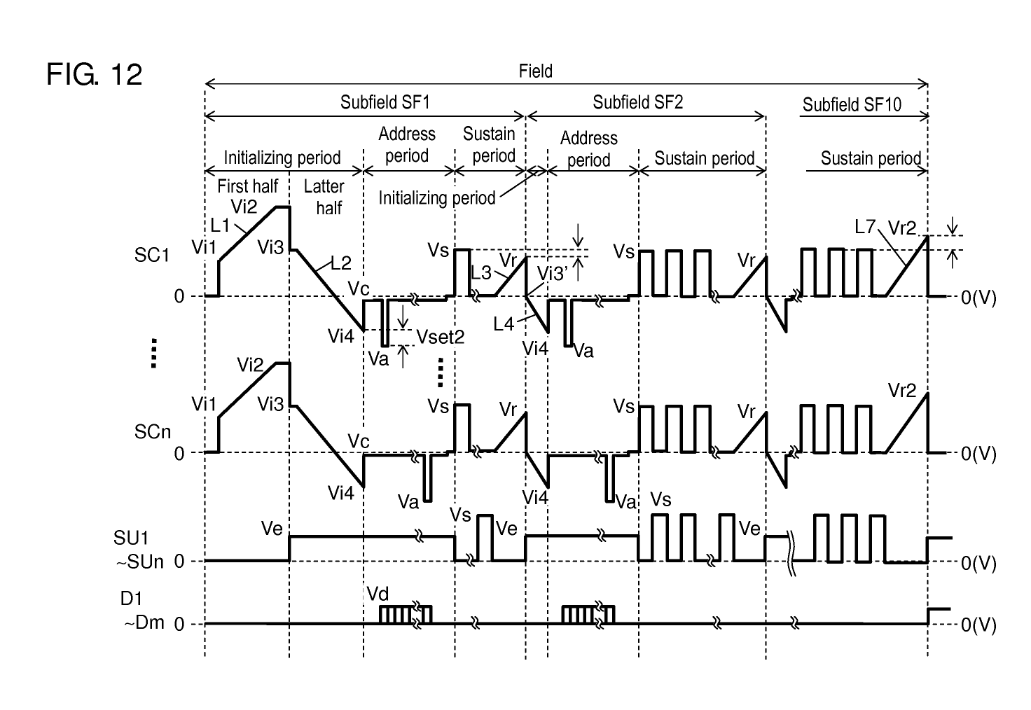

FIG. 12 is a diagram showing an example of a first driving voltage waveform that is to be applied to each electrode of panel 10 used in a plasma display apparatus in accordance with the third exemplary embodiment of the present invention.

FIG. 12 shows driving voltage waveforms applied to scan electrode SC1 for firstly undergoing an address operation in the address period, scan electrode SCn for finally undergoing the address operation in the address period, sustain electrode SU1 through sustain electrode SUn, and data electrode D1 through data electrode Dm.

The driving voltage waveforms of FIG. 12 are substantially the same as those of FIG. 3. The driving voltage waveforms of FIG. 12 are different from those of FIG. 3 in that erasing up-ramp voltage L7, instead of erasing up-ramp voltage L3, is generated at the end of the sustain period of the final subfield (subfield SF10).

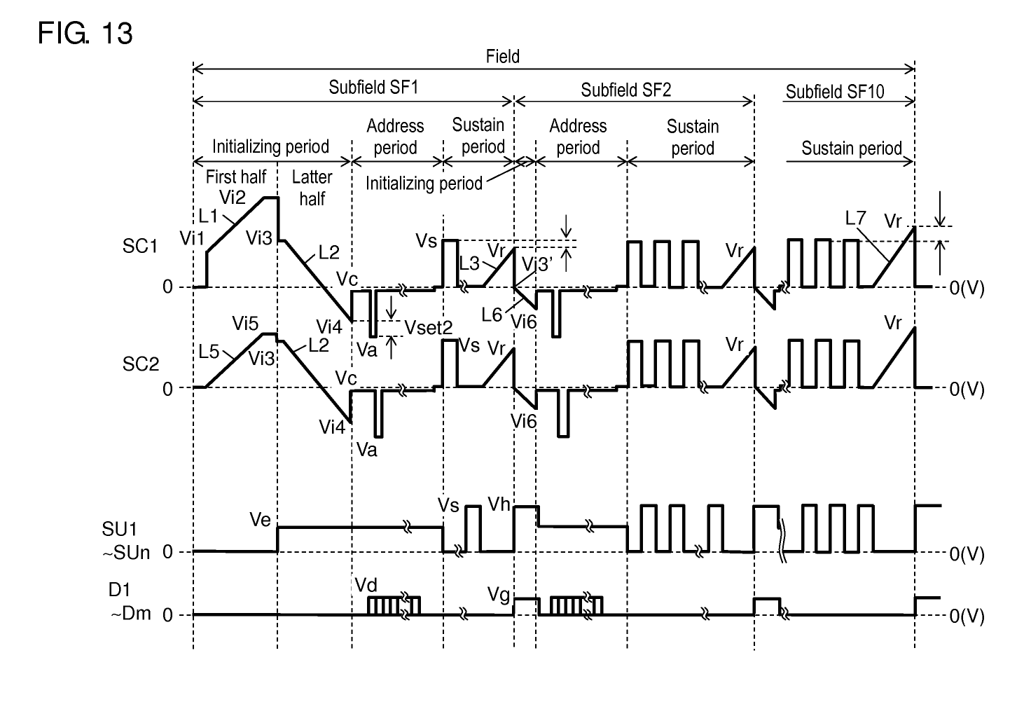

FIG. 13 is a diagram showing another example of the first driving voltage waveform that is to be applied to each electrode of panel 10 used in the plasma display apparatus in accordance with the third exemplary embodiment of the present invention.

FIG. 13 shows driving voltage waveforms applied to scan electrode SC1 for firstly undergoing an address operation in the address period, scan electrode SC2 for secondly undergoing the address operation in the address period, sustain electrode SU1 through sustain electrode SUn, and data electrode D1 through data electrode Dm.

The driving voltage waveforms of FIG. 13 are substantially the same as those of FIG. 9. The driving voltage waveforms of FIG. 13 are different from those of FIG. 9 in that erasing up-ramp voltage L7, instead of erasing up-ramp voltage L3, is generated at the end of the sustain period of the final subfield (subfield SF10).

Erasing up-ramp voltage L7 shown in FIG. 12 and FIG. 13 has a gradient the same as that of erasing up-ramp voltage L3, and is an up-ramp waveform voltage which increases to voltage Vr2 equal to or higher than voltage Vs. In the present exemplary embodiment, voltage Vr2 is set at about 255 (V), for example.

In the present exemplary embodiment, voltage Vr2 is set in the range from voltage Vs+0 (V) to voltage Vs+60 (V) based on the experiment performed by the inventor.

This setting is employed for the following reason:
erasing up-ramp voltage L7 causes feeble discharge in the discharge cell having undergone sustain discharge, but, when voltage Vr2 is set higher than the upper limit, discharge by erasing up-ramp voltage L7 becomes excessive, the emission luminance of the feeble light emission by this discharge increases, the luminance of black level (luminance generated by the discharge cell where sustain discharge is not caused) increases, and the contrast of the display image can be damaged.

In the present exemplary embodiment, thus, after generation of the final sustain pulse in the sustain period of the final subfield (subfield SF10), in the state where voltage 0 (V) is applied to sustain electrode SU1 through sustain electrode SUn and data electrode D1 through data electrode Dm, the up-ramp waveform voltage (erasing up-ramp voltage L7) is applied to scan electrode SC1 through scan electrode SCn. Here, the up-ramp waveform voltage gently increases from voltage 0 (V) lower than the discharge start voltage to voltage Vr2 equal to or higher than voltage Vs.

In the subfields other than the final subfield, similarly to the first exemplary embodiment and second exemplary embodiment, after generation of the final sustain pulse in the sustain period, in the state where voltage 0 (V) is applied to sustain electrode SU1 through sustain electrode SUn and data electrode D1 through data electrode Dm, the up-ramp waveform voltage (erasing up-ramp voltage L3) is applied to scan electrode SC1 through scan electrode SCn. Here, the up-ramp waveform voltage gently increases from voltage 0 (V) lower than the discharge start voltage to voltage Vr as a predetermined voltage. Voltage Vr is set at a voltage that is lower than voltage Vs and does not cause false discharge in the subsequent sustain period.

Thus, the address operation and sustain operation can be performed further stably, and the image display quality of panel 10 can be further improved.

When erasing up-ramp voltage L7 increasing to voltage Vr2 cannot be generated because of the constraint of the circuit configuration, an operation similar to the above-mentioned one can be performed by applying a waveform alternative to erasing up-ramp voltage L7 to scan electrode SC1 through scan electrode SCn in the final subfield of one field, and an operation similar to the above-mentioned one can be achieved.

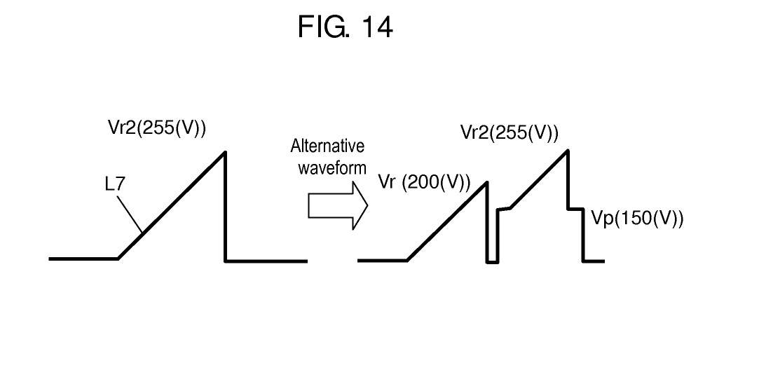

FIG. 14 is a diagram showing another example of the waveform of an up-ramp waveform voltage generated for performing an erasing operation in the sustain period of the final subfield in one field in accordance with the third exemplary embodiment of the present invention.

FIG. 14 also shows erasing up-ramp voltage L7 for comparison.

For example, only an up-ramp waveform voltage to voltage Vr can be generated in Miller integrating circuit 62. Therefore, a fixed voltage is applied to input terminal IN62 of Miller integrating circuit 62 to operate Miller integrating circuit 62, and an up-ramp waveform voltage which gently increases to voltage Vr is temporarily applied to scan electrode SC1 through scan electrode SCn. Voltage Vr is lower than voltage Vs (for example, voltage Vr=voltage Vs−15 (V)).

After the up-ramp waveform voltage arrives at voltage Vr, the operation of Miller integrating circuit 62 is stopped, and the voltage applied to scan electrode SC1 through scan electrode SCn is returned to voltage 0 (V).

Then, switching element Q71L1 through switching element Q71Ln are set at OFF, switching element Q71H1 through switching element Q71Hn are set at ON, thereby adding voltage Vp to reference potential A. In this state, Miller integrating circuit 62 is operated again. Thus, the waveform voltage can be generated by adding voltage Vp to the up-ramp waveform voltage generated by Miller integrating circuit 62. Therefore, an up-ramp waveform voltage increasing to a voltage higher than voltage Vr can be applied to scan electrode SC1 through scan electrode SCn.

After the voltage applied to scan electrode SC1 through scan electrode SCn increases to voltage Vr2, the operation of Miller integrating circuit 62 is stopped, switching element Q71L1 through switching element Q71Ln is set at ON, and switching element Q71H1 through switching element Q71Hn is set at OFF, thereby applying reference potential A to scan electrode SC1 through scan electrode SCn. Then, switching element Q56 is set at ON to set reference potential A at voltage 0 (V), and the voltage applied to scan electrode SC1 through scan electrode SCn is returned to voltage 0 (V).

Thus, a waveform having two peaks can be generated and can be applied to scan electrode SC1 through scan electrode SCn. The two peaks indicate the up-ramp waveform voltage which increases from voltage 0 (V) to voltage Vr (e.g. about 200 (V)) and the up-ramp waveform voltage which increases from voltage Vp (e.g. about 150 (V)) to voltage Vr2 (e.g. about 255 (V)). For example, such a waveform can be employed instead of erasing up-ramp voltage L7.

The present exemplary embodiment has described the configuration where the whole of the down-ramp waveform voltage (down-ramp voltage L4 or down-ramp voltage L6) has a constant gradient. However, the down-ramp waveform voltage may be divided into a plurality of periods, and the gradients in respective periods may be made different from each other.

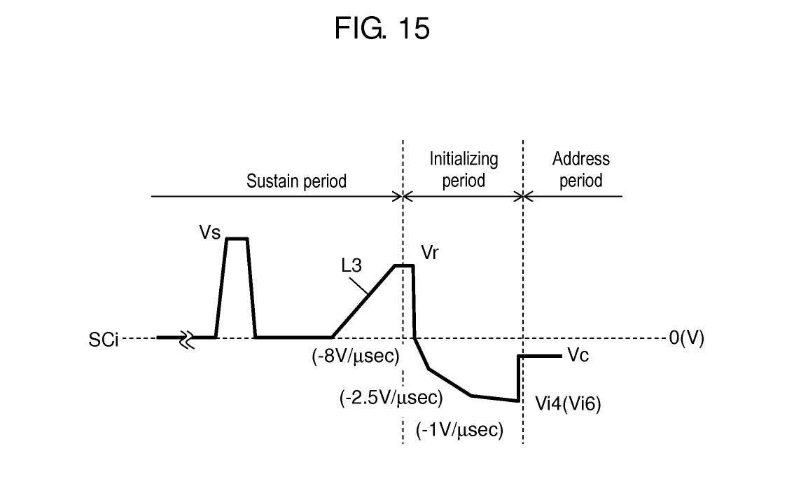

FIG. 15 is a waveform chart showing another example of the waveform of a down-ramp waveform voltage to be applied to scan electrode 22 in accordance with the exemplary embodiments of the present invention.

For example, as shown in FIG. 15, a down-ramp waveform voltage may be employed which decreases at a relatively steep gradient (e.g. −8 V/μsec) until initializing discharge occurs, then decreases at a gentle gradient (e.g. −2.5 V/μsec), and finally decreases at a gentler gradient (e.g. −1 V/μsec). It has been recognized that, an effect similar to the above-mentioned one can be produced also with such a configuration. In this configuration, an effect is also produced which can reduce the period for generating the down-ramp waveform voltage.

Alternatively, the down-ramp waveform voltage may be divided into two periods, and the gradients in respective periods may be made different from each other (not shown).

The present exemplary embodiment has described the configuration where either of the all-cell initializing operation and the selective initializing operation is performed in each of all subfields. However, the following configuration may be employed:
the panel is driven while a field where no all-cell initializing operation is performed in all discharge cells on the panel is generated.
   Also in such a case, the configuration shown in the present exemplary embodiment can be employed.

The number of subfields constituting one field, the subfield used as the forced initializing subfield, and the luminance weight of each subfield in the present invention are not limited to the above-mentioned numerical values. The subfield structure may be selected based on an image signal or the like.

The driving voltage waveforms of FIG. 3, FIG. 9, FIG. 11, FIG. 12, and FIG. 13 are simply one example of the exemplary embodiments of the present invention, and the present invention is not limited to these driving voltage waveforms.

The configurations of the driving circuits of FIG. 5, FIG. 6, FIG. 7, and FIG. 8 are also simply one example of the exemplary embodiments of the present invention, and the present invention is not limited to these circuit configurations.

Each circuit block shown in the exemplary embodiments of the present invention may be configured as an electric circuit for performing each operation shown in the exemplary embodiments, or may be configured using a microcomputer or the like programmed so as to perform a similar operation.

In the exemplary embodiments of the present invention, an example where one field is constituted by 10 subfields has been described. In the present invention, however, the number of subfields constituting one field is not limited to the above-mentioned value. For example, when the number of subfields is increased, the number of gradations displayable on panel 10 can be further increased. When the number of subfields is decreased, the time required for driving panel 10 can be shortened.

In the exemplary embodiments of the present invention, an example where one pixel is formed of discharge cells of three colors, namely red, green, and blue, has been described. However, also in a panel where one pixel is formed of discharge cells of four or more colors, the configurations shown in the exemplary embodiments of the present invention can be employed and a similar effect can be produced.

Each specific numerical value shown in the exemplary embodiments of the present invention is set based on the characteristics of panel 10 having a screen size of 50 inches and having 1024 display electrode pairs 24, and is simply one example in the exemplary embodiments. The present invention is not limited to these numerical values. Preferably, numerical values are set optimally in response to the specification and characteristics of the panel and the specification of the plasma display apparatus. These numerical values can vary in a range allowing the above-mentioned effect. The number of subfields constituting one field and the luminance weight of each subfield are not limited to the values shown in the exemplary embodiments of the present invention, but the subfield structure may be changed based on an image signal or the like.

### INDUSTRIAL APPLICABILITY

In the present invention, also when a panel having a high definition and large screen is driven, a stable address operation can be performed and a high-quality image can be displayed on the panel. The present invention is therefore useful as a driving method of a panel and a plasma display apparatus.

### REFERENCE MARKS IN THE DRAWINGS

10 panel
21 front substrate
22 scan electrode
23 sustain electrode
24 display electrode pair
25, 33 dielectric layer
26 protective layer
31 rear substrate
32 data electrode
34 barrier rib
35 phosphor layer
40 plasma display apparatus
41 image signal processing circuit
42 data electrode driver circuit
43 scan electrode driver circuit
44 sustain electrode driver circuit
45 timing generation circuit
50, 80 sustain pulse generation circuit
51, 81 power recovery circuit
60 ramp waveform voltage generation circuit
61, 62, 63 Miller integrating circuit
70 scan pulse generation circuit
85 fixed voltage generation circuit
Di11, Di12, Di21, Di22, Di62 diode
L11, L12, L21, L22 inductor
Q11, Q12, Q21, Q22, Q5, Q6, Q55, Q56, Q59, Q69, Q72, Q83, Q84, Q86, Q87, Q71H1 through Q71Hn, Q71L1 through Q71Ln, Q91H1 through Q91Hm, Q91L1 through Q91Lm switching element
C10, C20, C61, C62, C63 capacitor
R61, R62, R63, R9, R12, R13 resistor
Q61, Q62, Q63 transistor
IN61, IN62, IN63 input terminal
E71 power supply
L1, L5 up-ramp voltage
L2, L4, L6 down-ramp voltage
L3, L7 erasing up-ramp voltage

1. A driving method of a plasma display panel including a plurality of discharge cells each of which includes a data electrode and a display electrode pair formed of a scan electrode and a sustain electrode, the plasma display panel being driven by forming one field using a plurality of subfields, each of the subfields having an address period in which an address discharge is caused in a discharge cell to emit light and a sustain period in which sustain pulses varying from a base potential to a voltage at which a sustain discharge is caused in the discharge cell having undergone the address discharge are applied to the display electrode pairs,
the driving method comprising:
after generation of a final sustain pulse in the sustain period, applying an up-ramp waveform voltage to the scan electrodes, the up-ramp waveform voltage increasing from the base potential to a predetermined voltage; and
setting the predetermined voltage lower than the voltage of the sustain pulses.

2. A driving method of a plasma display panel including a plurality of discharge cells each of which includes a data electrode and a display electrode pair formed of a scan electrode and a sustain electrode, the plasma display panel being driven by forming one field using a plurality of subfields, each of the subfields having an address period in which an address discharge is caused in a discharge cell to emit light and a sustain period in which sustain pulses varying from a base potential to a voltage at which a sustain discharge is caused in the discharge cell having undergone the address discharge are applied to the display electrode pairs,
the driving method comprising:
after generation of a final sustain pulse in the sustain period in the subfields other than a final subfield in one field, applying an up-ramp waveform voltage to the scan electrodes, the up-ramp waveform voltage increasing from the base potential to a predetermined voltage set lower than the voltage of the sustain pulses; and
after generation of the final sustain pulse in the sustain period in the final subfield in one field, applying an up-ramp waveform voltage to the scan electrodes, the up-ramp waveform voltage increasing from the base potential to a voltage set equal to or higher than the voltage of the sustain pulses.

3. A driving method of a plasma display panel including a plurality of discharge cells each of which includes a data electrode and a display electrode pair formed of a scan electrode and a sustain electrode, the plasma display panel being driven by forming one field using a plurality of subfields, each of the subfields having an initializing period, an address period in which an address discharge is caused in a discharge cell to emit light, and a sustain period in which sustain pulses varying from a base potential to a voltage at which a sustain discharge is caused in the discharge cell having undergone the address discharge are applied to the display electrode pairs,
the driving method comprising:
forming a first-kind subfield and a second-kind subfield in one field,
the first-kind subfield having, in the initializing period:
scan electrodes to which an up-ramp waveform voltage increasing to a voltage at which a discharge occurs in the discharge cells and a first down-ramp waveform voltage decreasing to a negative voltage are applied; and
scan electrodes to which a voltage at which no discharge occurs in the discharge cells and the first down-ramp waveform voltage are applied,
in the second-kind subfield, a second down-ramp wave form voltage being applied to the scan electrodes in the initializing period, the second down-ramp waveform voltage decreasing to a voltage at which a discharge occurs only in the discharge cell having undergone an address discharge in the immediately preceding subfield;
applying a first voltage to the data electrodes in a period when the first down-ramp waveform voltage is applied to the scan electrodes in the initializing period of the first-kind subfield, and applying a second voltage higher than the first voltage to the data electrodes in a period when the second down-ramp waveform voltage is applied to the scan electrodes in the initializing period of the second-kind subfield,
after generation of a final sustain pulse in the sustain period in the subfields other than a final subfield in one field, applying an up-ramp waveform voltage to the scan electrodes, the up-ramp waveform voltage increasing from the base potential to a predetermined voltage set lower than the voltage of the sustain pulses; and
after generation of the final sustain pulse in the sustain period in the final subfield in one field, applying an up-ramp waveform voltage to the scan electrodes, the up-ramp waveform voltage increasing from the base potential to a voltage set equal to or higher than the voltage of the sustain pulses.

4. The driving method of the plasma display panel of claim 3, wherein
the second down-ramp waveform voltage is generated such that a lowest voltage of the second down-ramp waveform voltage is higher than a lowest voltage of the first down-ramp waveform voltage.

5. The driving method of the plasma display panel of claim 3, wherein
a positive voltage is applied to the sustain electrodes in a period when the first down-ramp waveform voltage is applied to the scan electrodes, and a voltage higher than the positive voltage is applied to the sustain electrodes in a period when the second down-ramp waveform voltage is applied to the scan electrodes.

6. The driving method of the plasma display panel of claim 3, wherein
the up-ramp waveform voltage applied to the scan electrodes after generation of the sustain pulses in the sustain period has a gradient steeper than a gradient of the up-ramp waveform voltage applied to the scan electrodes in the initializing period of the first-kind subfield.

7. A plasma display apparatus comprising:
a plasma display panel including a plurality of discharge cells each of which includes a data electrode and a display electrode pair formed of a scan electrode and a sustain electrode; and
a driver circuit for driving the plasma display panel by forming one field using a plurality of subfields, each of the subfields having an address period in which an address discharge is caused in a discharge cell to emit light and a sustain period in which sustain pulses varying from a base potential to a voltage at which a sustain discharge is caused in the discharge cell having undergone the address discharge are applied to the display electrode pairs,
wherein, after generation of a final sustain pulse in the sustain period, the driver circuit applies an up-ramp waveform voltage to the scan electrodes, the up-ramp waveform voltage increasing from a base potential to a predetermined voltage set lower than the voltage of the sustain pulses.

8. A plasma display apparatus comprising:
a plasma display panel including a plurality of discharge cells each of which includes a data electrode and a display electrode pair formed of a scan electrode and a sustain electrode; and
a driver circuit for driving the plasma display panel by forming one field using a plurality of subfields, each of the subfields having an address period in which an address discharge is caused in a discharge cell to emit light and a sustain period in which sustain pulses varying from a base potential to a voltage at which a sustain discharge is caused in the discharge cell having undergone the address discharge are applied to the display electrode pairs,
wherein,
after generation of a final sustain pulse in the sustain period in the subfields other than a final subfield in one field, the driver circuit applies an up-ramp waveform voltage to the scan electrodes, the up-ramp waveform voltage increasing from the base potential to a predetermined voltage set lower than the voltage of the sustain pulses, and
after generation of the final sustain pulse in the sustain period in the final subfield in one field, the driver circuit applies an up-ramp waveform voltage to the scan electrodes, the up-ramp waveform voltage increasing from the base potential to a voltage set equal to or higher than the voltage of the sustain pulses.

9. A plasma display apparatus comprising:
a plasma display panel including a plurality of discharge cells each of which includes a data electrode and a display electrode pair formed of a scan electrode and a sustain electrode; and
a driver circuit for driving the plasma display panel by forming one field using a plurality of subfields, each of the subfields having an initializing period, an address period in which an address discharge is caused in a discharge cell to emit light, and a sustain period in which sustain pulses varying from a base potential to a voltage at which a sustain discharge is caused in the discharge cell having undergone the address discharge are applied to the display electrode pairs,
wherein,
the driver circuit drives the plasma display panel by forming a first-kind subfield and a second-kind subfield in one field,
the first-kind subfield having, in the initializing period:
scan electrodes to which an up-ramp waveform voltage increasing to a voltage at which a discharge occurs in the discharge cells and a first down-ramp waveform voltage decreasing to a negative voltage are applied; and
scan electrodes to which a voltage at which no discharge occurs in the discharge cells and the first down-ramp waveform voltage are applied,
in the second-kind subfield, a second down-ramp wave form voltage being applied to the scan electrodes in the initializing period, the second down-ramp waveform voltage decreasing to a voltage at which a discharge occurs only in the discharge cell having undergone an address discharge in the immediately preceding subfield,
the driver circuit applies a first voltage to the data electrodes in a period when the first down-ramp waveform voltage is applied to the scan electrodes in the initializing period of the first-kind subfield, and applies a second voltage higher than the first voltage to the data electrodes in a period when the second down-ramp waveform voltage is applied to the scan electrodes in the initializing period of the second-kind subfield,
after generation of a final sustain pulse in the sustain period in the subfields other than a final subfield in one field, the driver circuit applies an up-ramp waveform voltage to the scan electrodes, the up-ramp waveform voltage increasing from the base potential to a predetermined voltage set lower than the voltage of the sustain pulses, and
after generation of the final sustain pulse in the sustain period in the final subfield in one field, the driver circuit applies an up-ramp waveform voltage to the scan electrodes, the up-ramp waveform voltage increasing from the base potential to a voltage set equal to or higher than the voltage of the sustain pulses.
